(19) United States
(12) Patent Application Publication
(10) Pub. No.: US 2025/0033399 A1
(43) Pub. Date: Jan. 30, 2025

(54) IMAGE FORMING SYSTEM AND POST-PROCESSING APPARATUS FOR PRODUCING BOOKLET BY BONDING PLURALITY OF SHEETS

(71) Applicant: CANON KABUSHIKI KAISHA, Tokyo (JP)

(72) Inventor: NOBUTOSHI SUGAI, Shizuoka (JP)

(21) Appl. No.: 18/783,884

(22) Filed: Jul. 25, 2024

(30) Foreign Application Priority Data
Jul. 28, 2023 (JP) 2023-123759

(51) Int. Cl. B42C 1/12; B42C 9/00; B42C 13/00

(52) U.S. Cl. CPC B42C 1/125; B42C 9/0006; B42C 13/00

(57) ABSTRACT

A conveyance roller conveys a plurality of sheet groups, each to which a bonding agent has been applied. A sheet holder holds the plurality of sheet groups by stacking a subsequent sheet group on a preceding sheet group. A thermocompression bonding unit produces a booklet by applying heat and pressure to the plurality of sheet groups held in the sheet holder. A controller obtains sheet information indicating a type of sheet or a conveyance duration of a preceding sheet group among a plurality of sheet groups, and controls a thermocompression bonding parameter to be applied to at least one subsequent sheet group of the preceding sheet group among the plurality of sheet groups in the thermocompression bonding unit based on the sheet information.

### BACKGROUND OF THE INVENTION

### Field of the Invention

The present invention relates to an image forming system and a post-processing apparatus for producing a booklet by bonding a plurality of sheets.

### Description of the Related Art

Post-processing apparatuses for producing a booklet from a plurality of sheets on which an image has been formed by an image forming apparatus are known. According to Japanese Patent Laid-Open No. 2004-209858, a post-processing apparatus for producing a booklet by bonding a plurality of sheets using a powder bonding agent is proposed.

Incidentally, when conveyance of a sheet to be included in a booklet is delayed, a duration required for producing the booklet increases, and productivity of a post-processing apparatus decreases. If a bonding duration of a booklet is shortened in order to maintain productivity, a sheet may detach from the booklet. Also if a type of a sheet conveyed to a post-processing apparatus is different from an expected type, an amount of heat supplied to the sheet may be insufficient, and the sheet may detach from the booklet. If the bonding duration is increased in advance, the productivity of a post-processing apparatus decreases. As described above, it is difficult to achieve both productivity and bonding strength.

### SUMMARY OF THE INVENTION

The present disclosure provides a post-processing apparatus comprising: a conveyance roller configured to convey a plurality of sheet groups, each to which a bonding agent has been applied; a sheet holder configured to hold the plurality of sheet groups by stacking a subsequent sheet group on a preceding sheet group; a thermocompression bonding unit configured to produce a booklet by applying heat and pressure to the plurality of sheet groups held in the sheet holder; and a controller configured to: obtain sheet information indicating a type of sheet or a conveyance duration of a preceding sheet group among a plurality of sheet groups; and control a thermocompression bonding parameter to be applied to at least one subsequent sheet group of the preceding sheet group among the plurality of sheet groups in the thermocompression bonding unit based on the sheet information.

Further features of the present invention will become apparent from the following description of exemplary embodiments (with reference to the attached drawings).

### BRIEF DESCRIPTION OF THE DRAWINGS

FIG. 1 is a diagram illustrating an image forming system.

FIGS. 2A and 2B are diagrams illustrating a printing region for a bonding agent.

FIGS. 3A to 3H are diagrams illustrating a buffer operation

FIGS. 4A to 4D are diagrams illustrating an alignment operation and a bonding operation.

FIGS. 5A and 5B are diagrams illustrating the bonding operation.

FIG. 6 is a diagram illustrating controllers.

FIG. 7 is a diagram illustrating functions of a CPU.

FIG. 8 is a timing chart related to conveyance and thermocompression bonding of sheets.

FIG. 9 is a timing chart related to conveyance and thermocompression bonding of sheets.

FIGS. 10A to 10C are diagrams illustrating tables to be used to obtain a correction value.

FIG. 11 is a flowchart for explaining thermocompression bonding processing.

FIG. 12 is a timing chart related to conveyance and thermocompression bonding of sheets.

FIG. 13 is a flowchart for explaining thermocompression bonding processing.

FIG. 14 is a timing chart related to conveyance and thermocompression bonding of sheets.

FIG. 15 is a flowchart for explaining thermocompression bonding processing.

FIG. 16 is a diagram illustrating the image forming system.

FIG. 17 is a diagram illustrating functions of the CPU.

FIGS. 18A to 18D are diagrams illustrating the alignment operation and the bonding operation.

FIG. 19 is a timing chart related to conveyance and thermocompression bonding of sheets.

FIG. 20 is a timing chart related to conveyance and thermocompression bonding of sheets.

FIG. 21 is a timing chart related to conveyance and thermocompression bonding of sheets.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### (1) Image Forming System

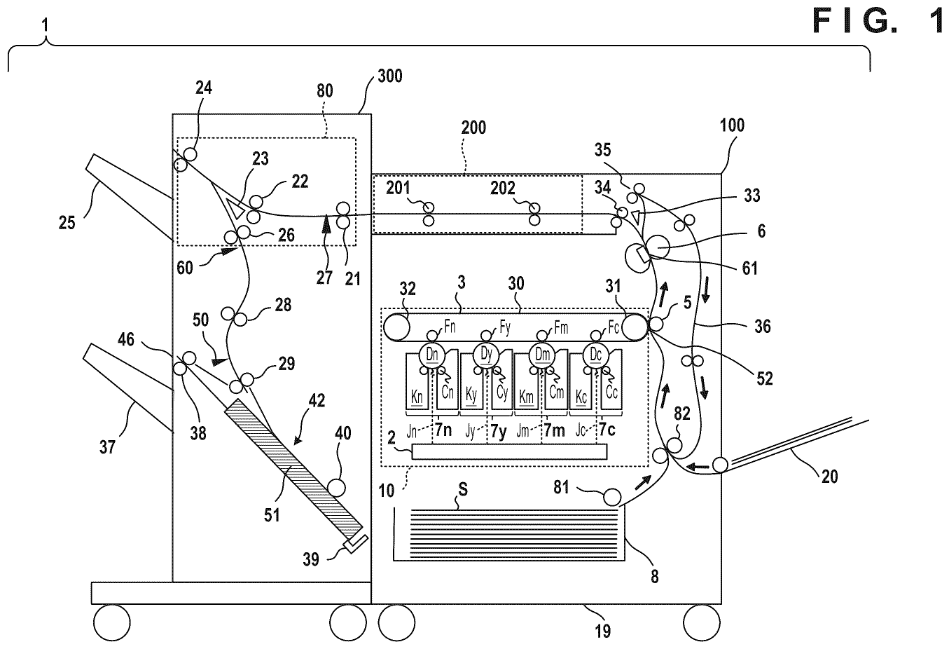

As illustrated in FIG. 1, an image forming system 1 includes an image forming apparatus 100 and a post-processing apparatus 300. The post-processing apparatus 300 is a sheet processing apparatus connected to the image forming apparatus 100. The image forming apparatus 100 forms an image on a sheet S, which is a printing material. Intermediate conveyance rollers 200 convey the sheet S on which the image has been formed to the post-processing apparatus 300. The post-processing apparatus 300 performs post-processing on the sheet S as necessary and outputs the sheet S.

The image forming apparatus 100 includes a sheet cassette 8, an image forming unit 10, a fixing device 6, and a housing 19, which houses these. The image forming unit 10 forms a toner image on a sheet S fed from the sheet cassette 8. The fixing device 6 executes fixing processing for fixing the toner image on the sheet S.

The sheet cassette 8 is provided at a lower portion of the image forming apparatus 100. The sheet cassette 8 is inserted so as to be capable of being pulled out from the housing 19 and can store a large number of sheets S. A feeding roller 81 feeds a sheet S from the sheet cassette 8 and passes the sheet S to a pair of conveyance rollers 82. A multi-tray 20 can also feed sheets S one at a time. The image forming unit 10 is a tandem-type electrophotographic unit including four process cartridges 7n, 7y, 7m, and 7c, a scanner unit 2, and a transfer unit 3. n assigned to reference numerals means a bonding agent. y, m, and c mean yellow, magenta, and cyan, respectively. Regarding the process cartridges 7n, 7y, 7m, and 7c, a plurality of components responsible for image forming processing can be replaced in an integrated manner. That is, the process cartridges 7n, 7y, 7m, and 7c are formed by a plurality of components being integrated.

The process cartridges 7n, 7y, 7m, and 7c include corresponding toner containers Kn, Ky, Km, and Kc, photosensitive drums Dn, Dy, Dm, and Dc, and charging rollers Cn, Cy, Cm, and Cc. The structures of the process cartridges 7n, 7y, 7m, and 7c are substantially the same except for a type of toner.

The toner containers Ky, Km, and Kc contain yellow, magenta, and cyan toner for forming a visible image on a sheet S. The toner container Kn contains bonding toner Tn. The bonding toner Tn is a powder bonding agent used for bonding a plurality of sheets S by thermocompression in the post-processing apparatus 300. A bonding toner image is formed on the photosensitive drum Dn by being developed using the bonding toner Tn. The bonding toner image is not intended to convey visual information. Therefore, the bonding toner image is different from a toner image (normal toner image) formed using printing toner for printing an image, such as a shape or text, on a sheet S. However, in the following description, the bonding toner Tn is applied to a sheet S in a predetermined application pattern. Therefore, a layered bonding toner Tn image developed by an electrophotographic process is also treated as one of the “toner images”.

When printing a black image, such as text, a black image (process black) is realized by overlapping yellow, magenta, and cyan toner. However, the image forming unit 10 may include a fifth process cartridge in which black toner is used. The types and the number of printing toners can be changed according to the purpose of the image forming apparatus 100.

The charging rollers Cn, Cy, Cm, and Cc are charging devices and uniformly charge the surfaces of the respective corresponding photosensitive drums Dn, Dy, Dm, and Dc. The scanner unit 2 is arranged below the process cartridges 7n, 7y, 7m, and 7c and above the sheet cassette 8. The scanner unit 2 forms electrostatic latent images by irradiating the photosensitive drums Dn, Dy, Dm, and Dc with respective corresponding laser beams Jn, Jy, Jm, and Jc. The scanner unit 2 may be referred to as an exposure device or an optical scanning device.

The toner containers Kn, Ky, Km, and Kc form toner images by adhering toner to electrostatic latent images on the photosensitive drums Dn, Dy, Dm, and Dc. The toner containers Kn, Ky, Km, and Kc may be referred to as developing devices.

The transfer unit 3 includes a transfer belt 30 serving as an intermediate transfer member (secondary image carrier). The transfer belt 30 is an endless belt wound around an inner roller 31 and a tension roller 32. An outer peripheral surface (image forming surface) of the transfer belt 30 faces the photosensitive drums Dn, Dy, Dm, and Dc. Primary transfer rollers Fn, Fy, Fm, and Fc are arranged on an inner peripheral side of the transfer belt 30 so as to face the photosensitive drums Dn, Dy, Dm, and Dc.

The primary transfer rollers Fn, Fy, Fm, and Fc transfer toner images from the corresponding photosensitive drums Dn, Dy, Dm, and Dc to the transfer belt 30. The primary transfer rollers Fn, Fy, Fm, and Fc may be referred to as a primary transfer device. By the transfer belt 30 rotating counterclockwise, the toner images are conveyed to a secondary transfer portion.

A secondary transfer roller 5 is arranged so as to face the inner roller 31, and a transfer nip 52 is formed between the secondary transfer roller 5 and the transfer belt 30. The transfer nip 52 transfers toner images from the transfer belt 30 to a sheet S. The transfer nip 52 may be referred to as the secondary transfer portion.

The fixing device 6 is arranged above the secondary transfer roller 5 (downstream in the conveyance direction of a sheet S). The fixing device 6 applies heat and pressure to a sheet S passing through a fixing nip 61. As a result, toner images are fixed on the sheet S. That is, printing toner Ty, Tm, and Tc and the bonding toner Tn are melted and fixed on the sheet S.

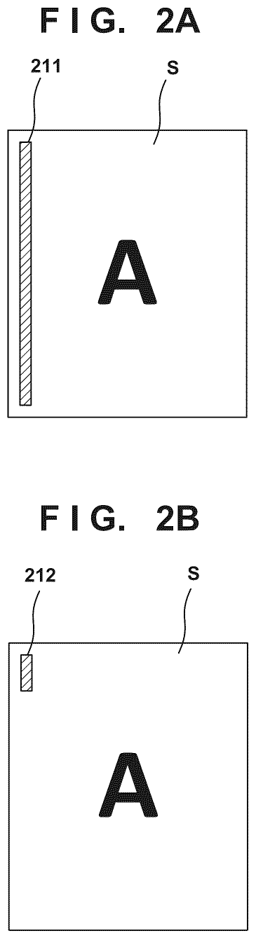

FIG. 2A illustrates a printing region 211 for the bonding toner Tn. The printing region 211 extends parallel to a long side of a sheet S. The printing region 211 is provided at an edge portion close to the long side. As a result, by the post-processing apparatus 300 stacking a plurality of sheets S and applying heat and pressure to the printing region 211 of the plurality of sheets S, the plurality of sheets S are bonded, and a booklet is formed. The booklet in this case is a booklet bound on a long side. Here, a width (length in a short-side direction) of a bonding toner image (printing region 211) is, for example, 4.0 mm.

As illustrated in FIG. 2B, a small printing region 212 for the bonding toner Tn may be formed near a corner of a sheet S. As a result, a booklet bound on a corner is produced. An image for which the bonding toner Tn is used is not formed on a sheet S serving as the front cover of a booklet.

As illustrated in FIG. 1, a switching guide 33 is a flap-shaped guide member provided downstream of the fixing device 6 in the conveyance direction of a sheet S. When single-sided printing mode for forming an image on one side of a sheet S is selected, the switching guide 33 guides a sheet S to discharge rollers 34. When double-sided printing mode for forming an image on both sides of a sheet S is selected, the switching guide 33 guides a sheet S on which an image has been formed on a first surface to a pair of switchback rollers 35. The pair of switchback rollers 35 conveys the sheet S in a first direction. When a state in which the trailing edge of the sheet S can enter a double-sided conveyance path 36 is entered, the pair of switchback rollers 35 starts reversing. As a result, the sheet S is conveyed to the double-sided conveyance path 36. The double-sided conveyance path 36 conveys the sheet S to the secondary transfer portion again. As a result, an image is formed on a second surface of the sheet S. A bonding toner image may be formed on both the first surface and the second surface.

The discharge rollers 34 convey a sheet S to the intermediate conveyance rollers 200. The intermediate conveyance rollers 200 include pairs of conveyance rollers 201 and 202. The pairs of conveyance rollers 201 and 202 convey the sheet S to the post-processing apparatus 300.

### (2) Post-Processing Apparatus

The post-processing apparatus 300 is a floor-standing-type sheet processing apparatus. The post-processing apparatus 300 includes a function for buffering a plurality of sheets, a function for aligning a plurality of sheets, and a function for bonding a sheet bundle.

Hereinafter, an edge portion of a sheet S on a front side in the conveyance direction is referred to as a leading edge. An edge portion of a sheet S on a back side in the conveyance direction is referred to as a trailing edge. Of the two edge portions of a sheet S, an edge portion that first enters the post-processing apparatus 300 is referred to as a first edge. Of the two edge portions of a sheet S, an edge portion that enters the post-processing apparatus 300 later is referred to as a second edge. In some cases, the leading edge is changed from the first edge to the second edge, and the trailing edge is changed from the second edge to the first edge by switchback conveyance executed by the post-processing apparatus 300.

A sheet S conveyed from the intermediate conveyance rollers 200 is transferred to inlet rollers 21 of the post-processing apparatus 300. A sheet sensor 27 is arranged downstream of the inlet rollers 21. When the sheet sensor 27 detects the trailing edge of the sheet S, a pair of conveyance rollers 22 accelerates the sheet S. When the trailing edge of a sheet S for which an upper tray 25 is set as a discharge destination arrives between the pair of conveyance rollers 22 and a pair of conveyance rollers 24, the pair of conveyance rollers 22 decelerates. As a result, the conveyance velocity of the sheet S becomes a predetermined discharge speed. The pair of conveyance rollers 24 discharges the sheet S to the upper tray 25.

When the trailing edge of a sheet S for which a lower tray 37 is set as a discharge destination exits a backflow prevention valve 23, the pair of conveyance rollers 24 stops the conveyance of the sheet S. Then, the pair of conveyance rollers 24 starts reverse rotation. As a result, the sheet S is switched back and conveyed to a pair of conveyance rollers 26. When a sheet sensor 60 provided downstream of the pair of conveyance rollers 26 detects the leading edge of the sheet S, two rollers constituting the pair of conveyance rollers 24 are separated. As a result, the pair of conveyance rollers 24 can receive a subsequent sheet S. Further, the pair of conveyance rollers 26 is stopped while nipping the preceding sheet S. The pair of conveyance rollers 26 starts reverse rotation in accordance with the arrival of the subsequent sheet S. As a result, the subsequent sheet S is stacked on the preceding sheet S. By the pair of conveyance rollers 26 repeating the switchback of a sheet S, a plurality of sheets S are stacked, and a sheet bundle is formed. Such a sheet bundle forming operation may be referred to as a buffer operation. A unit that realizes the buffer operation is referred to as a buffer unit 80.

When a sheet bundle is completed in the buffer unit 80, the pair of conveyance rollers 26 conveys the sheet bundle toward an intermediate stack section 42. The sheet bundle passes through a pair of conveyance rollers 28 and a sheet sensor 50. Further, the sheet bundle is conveyed to the intermediate stack section 42 by kick-out rollers 29. A movable vertical alignment plate 39 is arranged at a standby position in the most downstream portion of the intermediate stack section 42. By the sheet bundle abutting the vertical alignment plate 39, the sheet bundle is aligned.

A plurality of sheet bundles are sequentially stacked in the intermediate stack section 42. As a result, a predetermined number of sheets S forming a booklet are stacked in the intermediate stack section 42. When the alignment of the predetermined number of sheets S is completed, a booklet is formed by a thermocompression bonding unit 51 executing a binding operation (bonding processing). By the vertical alignment plate 39 moving from the standby position to a discharge position, the booklet is pushed toward discharge rollers 38. When the leading edge of the booklet is nipped by the discharge rollers 38, the vertical alignment plate 39 stops and returns to the standby position again. The discharge rollers 38 discharge the booklet received from the vertical alignment plate 39 from a discharge port 46 to the lower tray 37.

In the above description, the post-processing apparatus 300 forms a sheet bundle constituted by a plurality of sheets S using the buffer unit 80 and conveys the sheet bundle to the intermediate stack section 42. However, one sheet S may be conveyed to the intermediate stack section 42.

### (3) Buffer Operation (Stacking Operation)

The buffer operation is an operation for making a subsequent sheet or sheet bundle wait in the buffer unit 80 until post-processing for a preceding sheet bundle is completed in the intermediate stack section 42. The buffer operation makes it possible for the image forming system 1 to continue an image forming job that includes post-processing without decreasing productivity (number of images outputted per unit time) of the image forming apparatus 100.

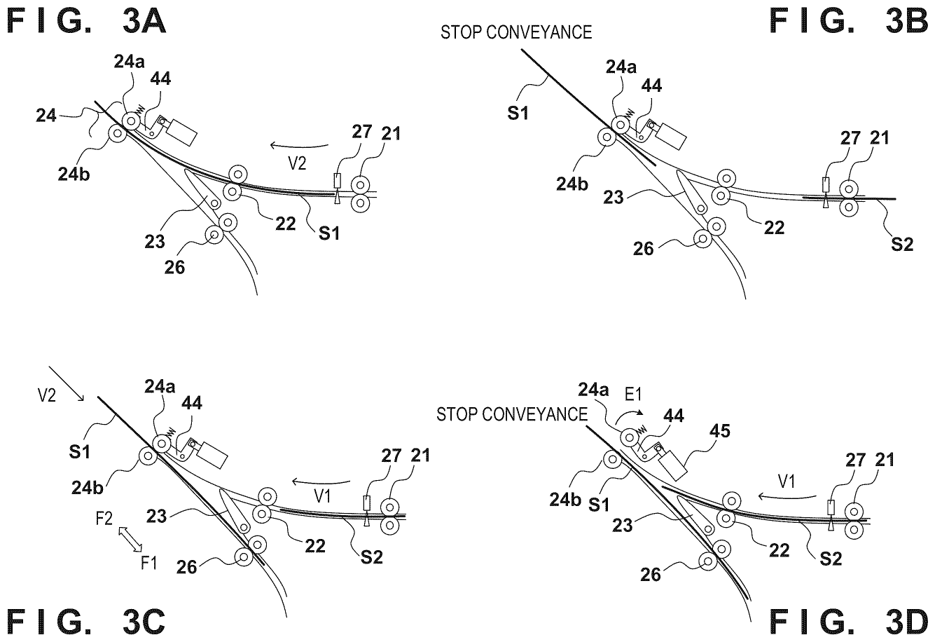

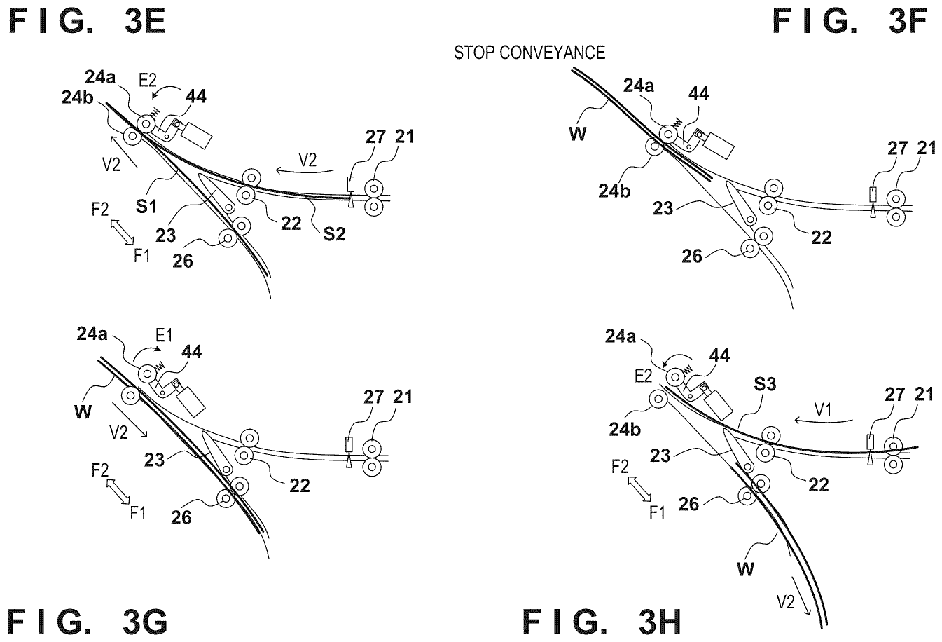

FIGS. 3A to 3G illustrate the buffer operation. Here, a sheet S conveyed first is denoted as S1. A sheet S conveyed second is denoted as S2. A sheet bundle formed by stacking the sheet S1 and the sheet S2 are denoted as W. The conveyance velocities of the pair of conveyance rollers 22, 24, and 26 are denoted as V1 and V2 (V1<V2). The conveyance velocity V1 is a conveyance velocity before acceleration, and the conveyance velocity V2 is a conveyance velocity after acceleration. Here, the acceleration (increase in velocity) is acceleration processing for ensuring a sheet interval (hereinafter referred to as paper interval) necessary for when stacking sheets S in the buffer unit 80 and for when feeding a sheet bundle downstream.

A sheet interval generally refers to a distance or a duration of conveyance from the trailing edge of a preceding sheet Si to the leading edge of a subsequent sheet Si+1 (where i is any integer).

FIG. 3A illustrates accelerating the conveyance velocities of the pair of conveyance rollers 22 and the pair of conveyance rollers 24 to V2 at a timing at which the trailing edge (second edge) of the sheet S1 passes through the sheet sensor 27. FIG. 3B illustrates the sheet S1 being temporarily stopped at a timing at which the trailing edge of the sheet S1 moves a predetermined distance from the sheet sensor 27 and exits the backflow prevention valve 23. The conveyance velocity of the pair of conveyance rollers 22 returns to V1 in order to receive the sheet S2. FIG. 3C illustrates the rotation direction of the pair of conveyance rollers 24 being switched from forward rotation to reverse rotation and the sheet S1 being conveyed in an F1 direction at the conveyance velocity V2. The sheet S2 is conveyed to the pair of conveyance rollers 22 at the conveyance velocity V1.

FIG. 3D illustrates the leading edge (first edge) of the sheet S1 being stopped at a position after being conveyed by a predetermined amount from the pair of conveyance rollers 26. At a timing at which the sheet S1 is nipped by the pair of conveyance rollers 26, a separation lever 44 separates an upper roller 24a in an E1 direction. After the upper roller 24a is separated from a lower roller 24b, the leading edge (first edge) of the sheet S2 passes through the pair of conveyance rollers 24. The separation lever 44 is connected to a plunger solenoid 45 so as to be capable of rotating about a solenoid connection shaft. When current flows through the plunger solenoid 45, the separation lever 44 rotates in the E1 direction, and the pair of conveyance rollers 24 enters a separated state. When the supply of current to the plunger solenoid 45 is stopped, the upper roller 24a is moved in an E2 direction by a pressing spring.

FIG. 3E illustrates accelerating the conveyance velocities of the pair of conveyance rollers 22 and the pair of conveyance rollers 24 to V2 after the trailing edge (second edge) of the sheet S2 passes through the sheet sensor 27. At a timing when the trailing edge (second edge) of the sheet S2 passes through the sheet sensor 27, the pair of conveyance rollers 26 starts reverse rotation. As a result, the sheet S1 nipped by the pair of conveyance rollers 26 is conveyed in an F2 direction. At a timing when the sheet S1 and the sheet S2 are conveyed at the same conveyance velocity, the upper roller 24a moves in the E2 direction and nips the sheet S1 and the sheet S2 in cooperation with the lower roller 24b. The conveyance velocity (peripheral velocity) of the pair of conveyance rollers 24 is adjusted to V2, which is the conveyance velocity of the sheet S1 and the sheet S2, before the pair of conveyance rollers 24 nips the sheet S1 and the sheet S2.

FIG. 3F illustrates the sheet S1 and the sheet S2 forming a sheet bundle W after the trailing edge (second edge) of the sheet S2 passes through the backflow prevention valve 23. As in FIGS. 3B and 3C, in FIG. 3F, the sheet bundle W is temporarily stopped at a timing at which the trailing edge of the sheet bundle W exits the backflow prevention valve 23, and the rotational direction of the pair of conveyance rollers 24 is switched from forward rotation to reverse rotation.

FIG. 3G illustrates the sheet bundle W being conveyed in the F1 direction at the conveyance velocity V2 toward a post-processing unit (thermocompression bonding unit 51). At a timing at which the sheet bundle W is nipped by the pair of conveyance rollers 26, the separation lever 44 separates the upper roller 24a from the lower roller 24b. That is, the upper roller 24a moves in the E1 direction.

FIG. 3H illustrates a sheet S3 being newly buffered after the sheet bundle W is sent to the thermocompression bonding unit 51. In this case, after the trailing edge of the sheet bundle W exits the pair of conveyance rollers 24, the upper roller 24a is temporarily stopped. The sheet S3 enters the pair of conveyance rollers 24 while the pair of conveyance rollers 24 is separated. When the trailing edge of the sheet S3 exits the sheet sensor 27, the conveyance velocity of the pair of conveyance rollers 22 is increased from V1 to V2. Then, the upper roller 24a moves in the E2 direction, and the pair of conveyance rollers 24 enters a contact state. The rotation direction of the upper roller 24a is switched from reverse rotation to forward rotation, and the sheet S3 is conveyed in the F2 direction at the conveyance velocity V2. The pair of conveyance rollers 24 starts conveying the sheet S3 before the trailing edge of the sheet S3 exits the pair of conveyance rollers 22.

Here, two sheets S1 and S2 are buffered, but this is only one example. When also buffering the third sheet S3, after FIG. 3G, the leading edge of the sheet bundle W is stopped at a position (temporary stop position) after being conveyed from the pair of conveyance rollers 26 by a predetermined amount. Then, the sheet bundle W and the sheet S3 are subjected to a stacking operation. The stacking operation is the same as the stacking operation of the sheet S1 and the sheet S2 described in connection with FIGS. 3D to 3G.

### (4) Alignment Operation

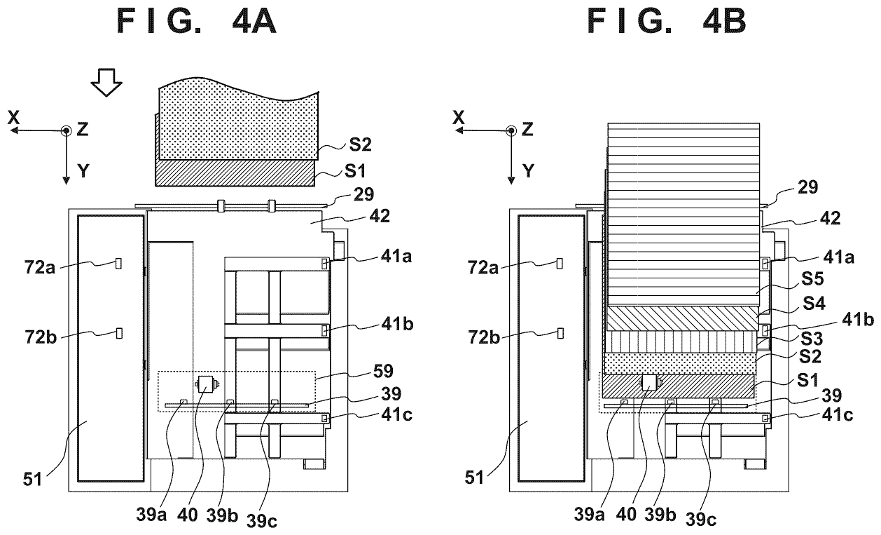

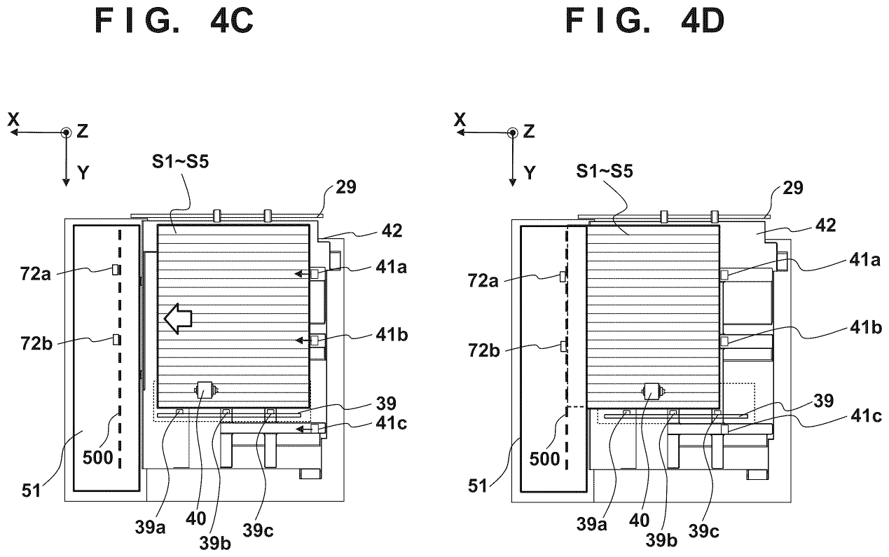

FIGS. 4A to 4D illustrate an alignment operation of sheets S executed in the intermediate stack section 42. An initial state is a state in which the intermediate stack section 42 is empty. As one example, a sheet bundle W constituted by five sheets S is conveyed from the buffer unit 80 to the intermediate stack section 42.

A Y direction is a direction parallel to a stacking surface (stacking plate) of a sheet S in the intermediate stack section 42 and parallel to the conveyance direction of a sheet S conveyed from the kick-out rollers 29 to the intermediate stack section 42. The Y direction may be referred to as a vertical direction. An X direction is a direction parallel to a stacking surface of a sheet S in the intermediate stack section 42 and orthogonal to the Y direction. The X direction may be referred to as a horizontal direction. A Z direction is a direction orthogonal to the X direction and the Y direction (direction of a normal of the stacking surface and thickness direction of stacked sheets S). The Z direction may be referred to as a height direction. Regarding the X, Y, and Z directions, opposite directions are sometimes referred to as −X, −Y, and −Z directions, respectively.

The vertical alignment plate 39 and a vertical alignment roller 40 function as a first alignment unit, which aligns a plurality of sheets S in a first direction (Y direction). The vertical alignment plate 39 is arranged at the most downstream portion of the intermediate stack section 42 in the Y direction. The vertical alignment plate 39 is a reference member (first reference member) serving as a reference for a sheet position in the Y direction. The vertical alignment roller 40 is a conveyance member that conveys sheets S in the Y direction in order to align the sheets S by causing them to abut the vertical alignment plate 39. The vertical alignment plate 39 includes a plurality of contact members 39a to 39c arranged so as to be spaced apart in the X direction. The plurality of contact members 39a to 39c contact an edge portion of sheets S. The vertical alignment plate 39 and the vertical alignment roller 40 are integrally formed as a movable unit 59, which is movable in the Y direction. The movable unit 59 is movable in the Y direction by a driving source, such as a motor. That is, the positions of the vertical alignment plate 39 and the vertical alignment roller 40 in the Y direction can be adjusted. Horizontal alignment joggers 41a to 41c function as a second alignment unit that aligns sheets in a second direction (X direction) perpendicular to the first direction.

The horizontal alignment joggers 41a to 41c are moved in the X direction by a driving source, such as a motor, and press a side edge of sheets S stacked on the intermediate stack section 42. Horizontal alignment plates 72a and 72b are reference members serving as a reference for a position of sheets S in the X direction. The horizontal alignment plates 72a and 72b are arranged so as to face the horizontal alignment joggers 41a and 41b in the X direction.

### (4-1) Preparatory Stage

As illustrated in FIG. 4A, sheets S1 to S5 are conveyed toward the kick-out rollers 29. The sheets S1 to S5 may be conveyed to the intermediate stack section 42 in a state in which a sheet Si positioned in a lower rank protrudes in the Y direction than a sheet Si+1 positioned in a higher rank. Before a sheet S is stacked in the intermediate stack section 42, the vertical alignment plate 39 is moved in advance to a predetermined standby position according to the size of sheets S to be aligned. The standby position is set such that a position of an edge portion of sheets S in the −Y direction is constant regardless of the size of sheets S. In other words, the standby position is a position at which a distance in the Y direction from a nip position of the kick-out rollers 29 to the vertical alignment plate 39 is slightly longer than a length of sheets in the Y direction. The horizontal alignment joggers 41a to 41c stand by at a position that is separated outward in the X direction from sheets S being conveyed so as not to interfere with the conveyance of the sheets S.

### (4-2) Vertical Alignment Stage

FIG. 4B illustrates the trailing edge of the first sheet S1 exiting the nip of the kick-out rollers 29 and the leading edge of the sheet S1 reaching the vertical alignment roller 40. The sheet S1 abuts the vertical alignment plate 39 and is aligned with the position of the vertical alignment plate 39 as the reference. By the vertical alignment roller 40 continuously rotating, the sheets S2 to S5 reaching the vertical alignment roller 40 subsequent to the sheet S1 sequentially abut the vertical alignment plate 39. As a result, the five sheets S1 to S5 are aligned in the Y direction (vertical direction) with the position of the vertical alignment plate 39 as the reference.

### (4-3) Horizontal Alignment Stage

FIG. 4C illustrates the alignment of the sheets S1 to S5 in the X direction (horizontal direction) being started after the alignment in the Y direction (vertical direction) is completed. The horizontal alignment joggers 41a to 41c are driven in the X direction which is an alignment direction, contacts a side edge of the sheets S1 to S5, and presses the sheets S1 to S5 toward the horizontal alignment plates 72a and 72b. Then, by the other side edge of the sheets S1 to S5 contacting a contact surface 500 of the horizontal alignment plates 72a and 72b, the sheets S1 to S5 are aligned in the X direction (horizontal direction) with the position of the horizontal alignment plates 72a and 72b as the reference.

### (4-4) Bonding Stage (Thermocompression Bonding Stage)

FIG. 4D illustrates a state in which the alignment of the five sheets S1 to S5 in the X direction and the Y direction is completed. A target position (alignment position) in the alignment operation is a position of the sheet bundle W for when the bonding processing (thermocompression bonding) is performed by the thermocompression bonding unit 51. As described above, the image forming apparatus 100 applies the bonding toner Tn to the sheets S1 to S5 such that sides on which a bonding toner image is formed are on the thermocompression bonding unit 51 side. When the sheet S1 is the front cover of a booklet, the bonding toner Tn is not applied.

The thermocompression bonding unit 51 subjects the sheets S1 to S5, which have been aligned, to a thermocompression bonding operation. During this time, the horizontal alignment joggers 41a to 41c retract in the −X direction. As a result, the intermediate stack section 42 enters a state in which it can receive the next plurality of sheets S. Then, a sheet bundle W constituted by sheets S6 to S10 generated by the buffer unit 80 is stacked on the sheets S1 to S5.

Then, the four steps described above are repeated for the sheets S1 to S10. As a result, the sheets S1 to S10 are bonded in state in which they are aligned in a precise manner.

As one example, a sheet bundle W is constituted by five sheets S. However, the number of sheets S constituting the sheet bundle W may be two or three, for example. That is, the number of sheets S included in the sheet bundle W may be less than or equal to a maximum number of sheets S that can be stacked by the buffer unit 80.

### (5) Thermocompression Bonding Unit

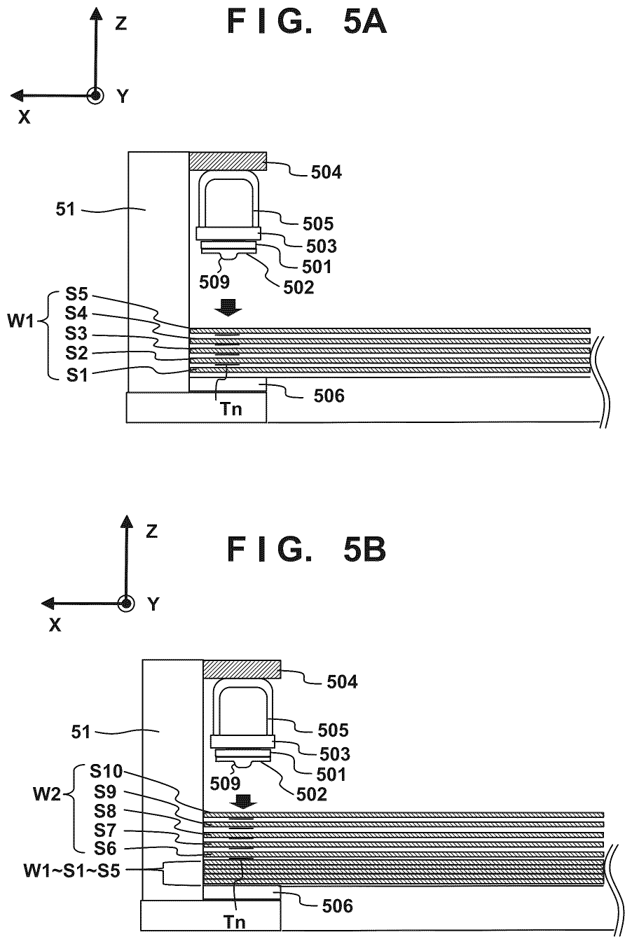

As illustrated in FIG. 5A, the thermocompression bonding unit 51 includes a heater 501 and a heating plate 502. The heater 501 incorporates a heating element as a heating source. The heating plate 502 is arranged on the heater 501 and is made of aluminum, for example. The heater 501 is a ceramic heater, for example. The temperature of the heater 501 may be measured by a temperature sensor and controlled by a control circuit such that the measured temperature is a target temperature. For example, the target temperature is set such that the surface temperature of a pressing portion 509 of the heating plate 502 is 200° C. By providing the pressing portion 509 in the heating plate 502, the heat and pressure of the thermocompression bonding unit 51 are concentrated at a binding position of a sheet bundle W. As a result, heating and pressing efficiency is improved.

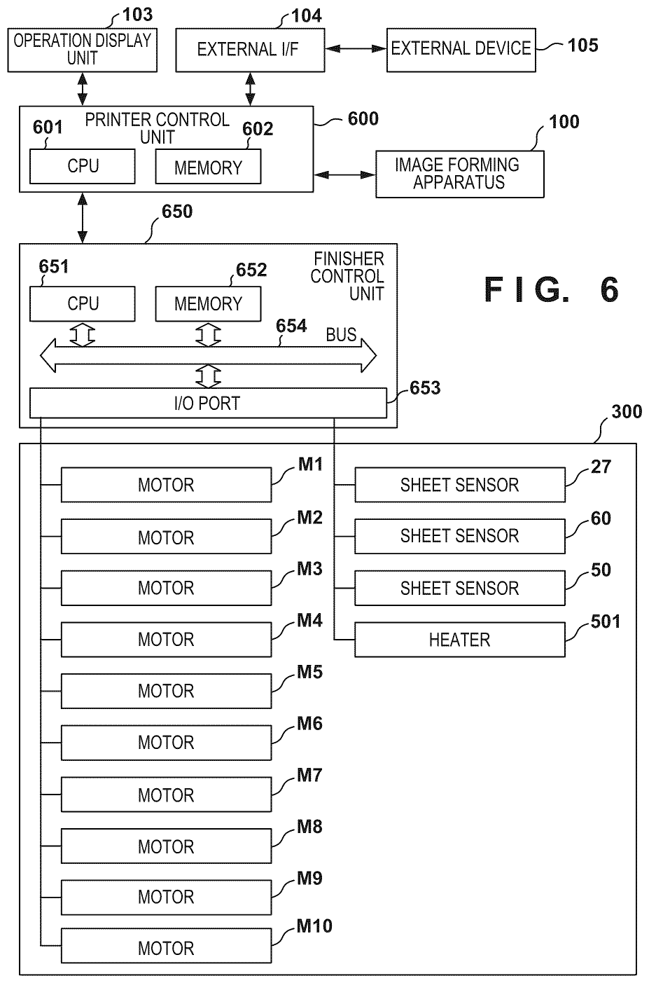

The heater 501 is supported by a heater support 503 made of resin. A pressing lever 504 obtains power from from a motor M8 illustrated in FIG. 6 in order to push the thermocompression bonding unit 51 down in the −Z direction (down direction) and press a sheet bundle W. The pressing force of the pressing lever 504 is transmitted to the pressing portion 509 via a metal stay 505, which is a rigid body. The pressing force of the pressing lever 504 can be controlled according to an amount by which the pressing lever 504 is moved in the −Z direction (down direction). For example, the pressing force is 30 kgf.

A pressing plate 506 is formed of an elastic material (e.g., silicone rubber). This is because the pressing plate 506 is a member for stably receiving the pressing force. The thermocompression bonding unit 51 presses a sheet bundle W1 constituted by sheets S1 to S5 and then separates from the sheet bundle W1. The sheets S1 to S5 of FIG. 5A indicate the first to fifth sheets of a booklet, which is a product. The sheet S1 is the front cover of the booklet. Therefore, a bonding toner Tn image is not formed on the sheet S1. Bonding toner Tn images are formed on the lower surfaces of second and subsequent sheets S2 to S5 of the booklet.

As illustrated in FIG. 5B, a sheet bundle W2 is stacked on the sheets S1 to S5 for which thermocompression bonding is completed. The sheet bundle W2 is constituted by sheets S6 to S10. The thermocompression bonding unit 51 subjects the sheet bundle W2 stacked on the sheet bundle W1 to the thermocompression bonding operation. As a result, a booklet constituted by many sheets S is produced.

The sheets S6 to S10, which are stacked later, are included in the same booklet as the sheets S1 to S5. Therefore, bonding toner Tn images are formed on the respective lower surfaces of the sheets S6 to S10.

As one example, the post-processing apparatus 300 can produce one booklet constituted by a maximum of 100 sheets S. When the production of a booklet is started, the buffer unit 80 produces a sheet bundle W by buffering a maximum of five sheets S at a time and feeds the sheet bundle W to the intermediate stack section 42. Each time a sheet bundle W arrives, the thermocompression bonding unit 51 performs the thermocompression bonding operation constituted by a lowering operation, a pressing operation, and a lifting operation. By repeating the buffer operation and the thermocompression bonding operation, a booklet is produced efficiently without decreasing the productivity of the image forming apparatus 100.

When the thermocompression bonding operation for a sheet bundle W including the last page of a booklet is completed in the intermediate stack section 42, the vertical alignment plate 39 is moved from the standby position to a discharge position. That is, by the vertical alignment plate 39 being translated toward the discharge port 46, the completed booklet is pushed out. The discharge rollers 38 are provided at the discharge port 46. When the leading edge of the booklet goes slightly past the discharge rollers 38, the vertical alignment plate 39 stops and returns to the standby position again. The discharge rollers 38 discharge the booklet to the lower tray 37.

### (6) Controllers

FIG. 6 is a diagram illustrating controllers of the image forming system 1. A printer control unit 600 is a controller that controls the image forming apparatus 100. A finisher control unit 650 is a controller that controls the post-processing apparatus 300. The printer control unit 600 and the finisher control unit 650 are connected to each other via a communication interface and control the operation of the image forming system 1 in cooperation with each other.

The printer control unit 600 includes a central processing unit (CPU) 601 and a memory 602. The CPU 601 reads and executes a program stored in the memory 602 and controls the image forming apparatus 100 according to the program. The CPU 601 executes image forming processing, sheet conveyance processing, and the like in the image forming apparatus 100. The memory 602 includes a non-volatile storage medium, such as a read-only memory (ROM), and a volatile storage medium, such as a random access memory (RAM). The memory 602 stores programs and data and provides a working area for when the CPU 601 executes the programs. The memory 602 is an example of a non-transitory storage medium storing a program for controlling the image forming apparatus 100.

The printer control unit 600 is connected to an external device 105, such as a personal computer and a portable information device, via an external interface (I/F) 104. The printer control unit 600 receives an instruction to execute an image forming job and the like for the image forming system 1, which are inputted from the external device 105. The printer control unit 600 is connected to an operation display unit 103, which is a user interface of the image forming system 1. The operation display unit 103 includes a display device (e.g., liquid crystal panel that presents information to a user) and an input device (e.g., physical button and touch sensor that accept an input operation by the user). By communicating with the operation display unit 103, the printer control unit 600 controls the display content of the display device and receives information inputted via the input device.

The finisher control unit 650 includes a CPU 651, a memory 652, and an I/O port 653. The CPU 651 reads and executes a program stored in the memory 652 and controls the post-processing apparatus 300 according to the program. The memory 652 includes a non-volatile storage medium (e.g., ROM, SSD, and HDD) and a volatile storage medium (e.g., RAM). SSD is an abbreviation for solid state drive. HDD is an abbreviation for hard disk drive. The memory 652 stores programs and data and provides a working area for when the CPU 651 executes the programs. The memory 652 is an example of a non-transitory storage medium storing a program for controlling the post-processing apparatus 300. The CPU 651, the memory 652, and the I/O port 653 are connected to each other via a bus 654. The I/O port 653 outputs control signals to and receives signals from various components of the post-processing apparatus 300.

Each function included in the printer control unit 600 and the finisher control unit 650 may be implemented as independent hardware, such as an ASIC, or may be implemented in software as a program module. ASIC is an abbreviation for application-specific integrated circuit. The printer control unit 600 may be responsible for some or all of the functions of the finisher control unit 650.

The I/O port 653 is connected with the sheet sensors 27, 50, and 60 and the heater 501. The I/O port 653 is connected with motors M1 to M10, which are driving sources for conveying a sheet S and a driving source of the thermocompression bonding unit 51.

The motor M1 rotationally drives the inlet rollers 21. The motor M2 rotationally drives the pair of conveyance rollers 22. The motor M3 rotationally drives the pair of conveyance rollers 24. The motor M4 rotationally drives the pair of conveyance rollers 26. The motor M5 rotationally drives the kick-out rollers 29. The motor M6 supplies a driving force for intermittently operating the vertical alignment roller 40 one rotation at a time. The motor M7 moves the horizontal alignment joggers 41 in the +X direction or −X direction. The motor M8 causes the thermocompression bonding unit 51 to perform an operation for bonding the sheet bundle W by pressure. The motor M9 rotationally drives the discharge rollers 38. The motor M10 drives the vertical alignment plate 39 in the +Y direction or −Y direction.

### (7) Functional Configuration

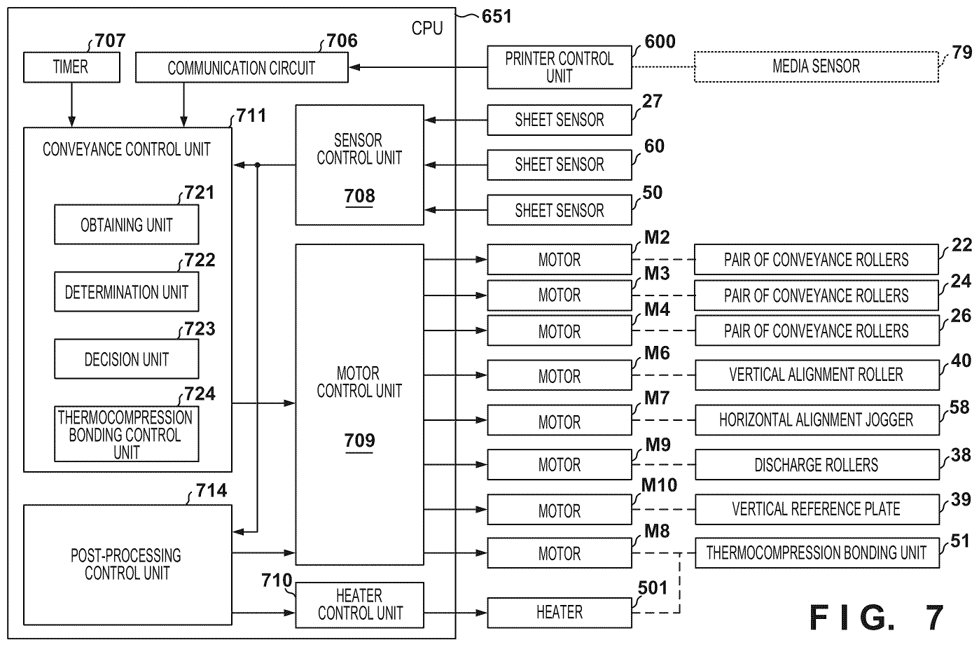

FIG. 7 illustrates functions realized by the CPU 651. The CPU 651 realizes a sensor control unit 708, a motor control unit 709, a heater control unit 710, a conveyance control unit 711, and a post-processing control unit 714 according to a program. Some or all of these functions may be realized by an ASIC, a digital signal processor (DSP), a field programmable gate array (FPGA), or the like. The CPU 651 may include a communication circuit 706 for executing serial communication and a timer 707, such as a real-time clock.

The communication circuit 706 is connected with the printer control unit 600 and receives information of a job or information of a sheet S conveyed from the image forming apparatus 100. The information of a sheet S may include the type of the sheet S designated by the user or the type of the sheet S detected by a media sensor 79 connected to the printer control unit 600. The communication circuit 706 instructs the printer control unit 600 to temporarily stop an image forming job.

The sensor control unit 708 activates the sheet sensors 27, 50, and 60 and transfers signals inputted from the sheet sensors 27, 50, and 60 to the conveyance control unit 711. The conveyance control unit 711 instructs the motor control unit 709 to drive the motors M1 to M5, mainly based on input from the sensor control unit 708. As a result, the conveyance control of a sheet S, a sheet bundle W, and a booklet is realized. The post-processing control unit 714 instructs the motor control unit 709 to drive the motors M6 to M10 and instructs the heater control unit 710 to start heating the heater 501 based on input from the sensor control unit 708. As a result, post-processing, such as vertical alignment processing, horizontal alignment processing, and thermocompression bonding operation, is realized.

The conveyance control unit 711 may include an obtaining unit 721, a determination unit 722, a decision unit 723, a thermocompression bonding control unit 724, and the like. The obtaining unit 721 measures a conveyance duration from a timing at which the leading edge of a sheet S or a sheet bundle W is detected by the sheet sensor 60 to a timing at which the leading edge of the sheet S or the sheet bundle W is detected by the sheet sensor 50, using a timer 707. The conveyance duration may be referred to as sheet information. Alternatively, the obtaining unit 721 obtains sheet information transmitted from the printer control unit 600, using the communication circuit 706. The sheet information indicates, for example, the type (e.g., material, grammage, presence or absence of coating) of each sheet S.

The determination unit 722 determines whether there is a delay in conveyance to the intermediate stack section 42 for each sheet S or for each sheet bundle W based on the conveyance duration, which is sheet information. For example, it is determined whether the conveyance duration exceeds a predetermined threshold duration.

The decision unit 723 decides thermocompression bonding parameters to be applied for each sheet S or for each sheet bundle W based on the sheet information. The thermocompression bonding parameters may include, for example, a duration of bonding (thermocompression bonding duration) by the thermocompression bonding unit 51, the heating temperature of the heater 501, a pressing force to be applied to the sheet S or the sheet bundle W by the pressing portion 509 pushed down by the motor M8, and the like.

The thermocompression bonding control unit 724 controls the motors M8 and M10 through the motor control unit 709 and controls the heater 501 through the heater control unit 710 based on the thermocompression bonding parameters decided by the decision unit 723.

### (8) Buffer Operation and Thermocompression Bonding

The image forming system 1 can successively produce a plurality of booklets. Upon receiving information of a job from the external device 105 via the communication circuit 706, the conveyance control unit 711 obtains the total number U of pages included in the job. Here, it is assumed that the total number U does not exceed a maximum number Q of sheets S (e.g., Q=100 sheets) that can be stacked on the stacking plate of the intermediate stack section 42. The number of sheets S included in one booklet is defined as M. A maximum number of sheets S included in a sheet bundle W produced by the buffer unit 80 is defined as N.

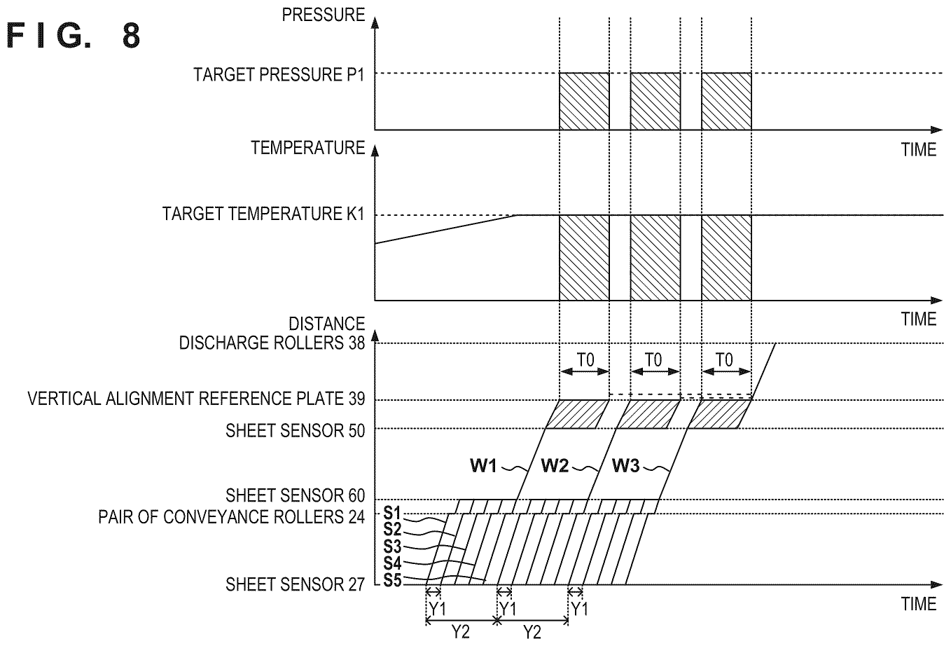

FIG. 8 is a diagram illustrating the buffer operation and thermocompression bonding. The horizontal axes indicate time. The vertical axes indicate a conveyance distance and the temperature and pressure of the thermocompression bonding unit 51. In FIG. 8, the positions of the leading edges of sheets S in the conveyance direction are plotted. Therefore, until the sheets S arrive at the pair of conveyance rollers 24, the positions of the first edges of the sheets S are plotted. After the sheets S are fed from the pair of conveyance rollers 24, the positions of the second edges of the sheets S are plotted.

As illustrated in FIG. 8, five sheets S1 to S5, are fed from the image forming apparatus 100 to the buffer unit 80 at regular intervals. The buffer unit 80 forms a sheet bundle W1 by stacking five sheets S1 to S5 and feeds the sheet bundle W1 to the intermediate stack section 42. The thermocompression bonding unit 51 executes thermocompression bonding on the sheet bundle W1. Then, the buffer unit 80 produces a sheet bundle W2 and feeds it to the intermediate stack section 42. The thermocompression bonding unit 51 executes thermocompression bonding on the sheet bundles W1 and W2 held in the intermediate stack section 42. The buffer unit 80 produces a sheet bundle W3 and feeds it to the intermediate stack section 42. The thermocompression bonding unit 51 executes thermocompression bonding on the sheet bundles W1, W2, and W3 held in the intermediate stack section 42. When a booklet constituted by the sheet bundles W1, W2, and W3 is completed, the vertical alignment plate 39 pushes out the booklet. The discharge rollers 38 discharge the booklet to the lower tray 37.

As illustrated in FIG. 8, the conveyance intervals between the respective sheets S are Y1. The conveyance intervals between the respective sheet bundles W are Y2. A duration from when a sheet bundle W is conveyed to the intermediate stack section 42 until thermocompression bonding is completed is TO.

The surface temperature of the heater 501 of the thermocompression bonding unit 51 is controlled to be a target temperature K1. The total pressure to be applied on a sheet bundle W for the thermocompression bonding duration TO is controlled to be a target pressure P1.

The sheet bundle W1 remains in the intermediate stack section 42 even after being subjected to thermocompression bonding in the intermediate stack section 42. Therefore, the subsequent sheet bundles W2 and W3 are sequentially stacked on the sheet bundle W1. When thermocompression bonding is performed on the sheet bundle W2, the sheet bundle W1 is also subjected to thermocompression bonding. When thermocompression bonding is performed on the sheet bundle W3, the sheet bundles W1 and W2 are also subjected to thermocompression bonding.

### (9) Recovery for Conveyance Delay

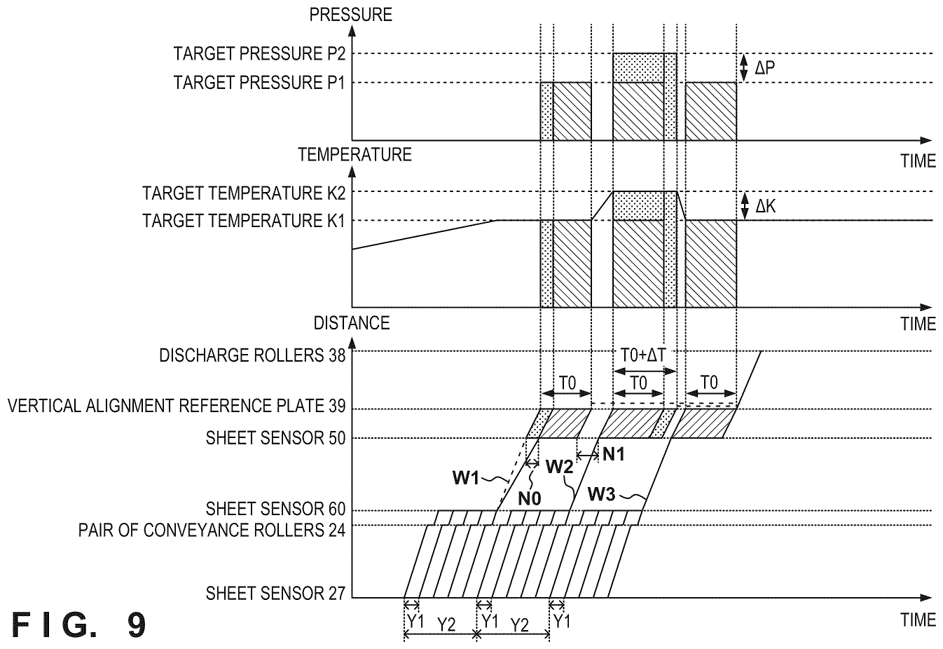

As illustrated in FIG. 9, a sudden conveyance slip may occur in the pair of conveyance rollers 26 or the pair of conveyance rollers 28. As a result, a conveyance duration necessary for the sheet bundle W1 to be conveyed from the sheet sensor 60 to the sheet sensor 50 may be longer than an expected duration. A difference between the conveyance duration and the expected duration is referred to as a delay duration N0.

When a conveyance delay of the delay duration N0 occurs, a time at which post-processing of the sheet bundle W1 is completed is also delayed by N0. A margin of conveyance duration between the sheet bundle W1 and the sheet bundle W2 is assumed to be N1. When N0≤N1, a post-processing duration of the sheet bundle W1 is maintained at a constant, and the start time and the end time of the post-processing duration are each shifted by N0.

However, in some cases, N0>N1 and the sheet bundle W2 is conveyed to the sheet sensor 50 without delay. In this case, the sheet bundle W2 enters the intermediate stack section 42 before thermocompression bonding for the sheet bundle W1 is completed, and a jam may occur.

Therefore, the CPU 651 decreases the thermocompression bonding duration of the sheet bundle W1 by a shortage duration ΔN. In this case, the following relationship is established between the delay duration N0, the margin N1, and the shortage duration ΔN.

$$Δ N = N 0 - N 1 \qquad Eq 1$$

This equation implies the following. Due to the conveyance delay of the sheet bundle W1, the start time of thermocompression bonding is N0 after a specified time. However, since the thermocompression bonding duration of the sheet bundle W1 is shortened by the shortage duration ΔN, the end time of thermocompression bonding of the sheet bundle W1 is N1 after a specified time. As a result, a jam is less likely to occur.

When the thermocompression bonding duration of the sheet bundle W1 is shortened, a heating amount necessary for achieving a target strength for the bonding strength of the sheet bundle W1 is insufficient compared to a target heating amount. As a result, a sheet S may detach from the booklet. As described above, the sheet bundle W1 is also bonded by thermocompression in the thermocompression bonding of the sheet bundle W2. Therefore, the CPU 651 adds a heating amount that is lacking in the preceding sheet bundle W to a heating amount for thermocompression bonding of the subsequent sheet bundle W. As a result, the shortage in the heating amount of the preceding sheet bundle W is compensated for. As one example, the shortage duration ΔN for the sheet bundle W1 is converted into at least one of a correction value ΔT for the heating duration, a correction value ΔK for the heating temperature, and a correction value ΔP for the pressing force for the sheet bundle W2.

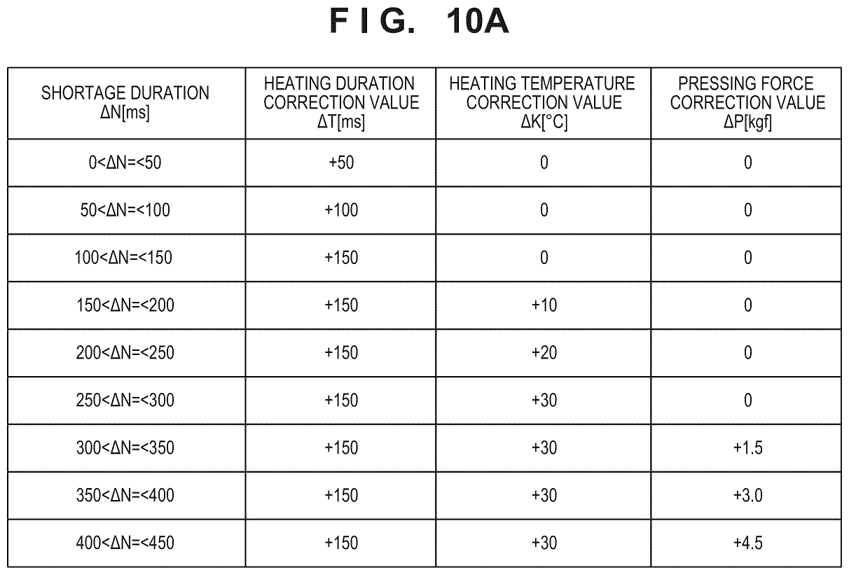

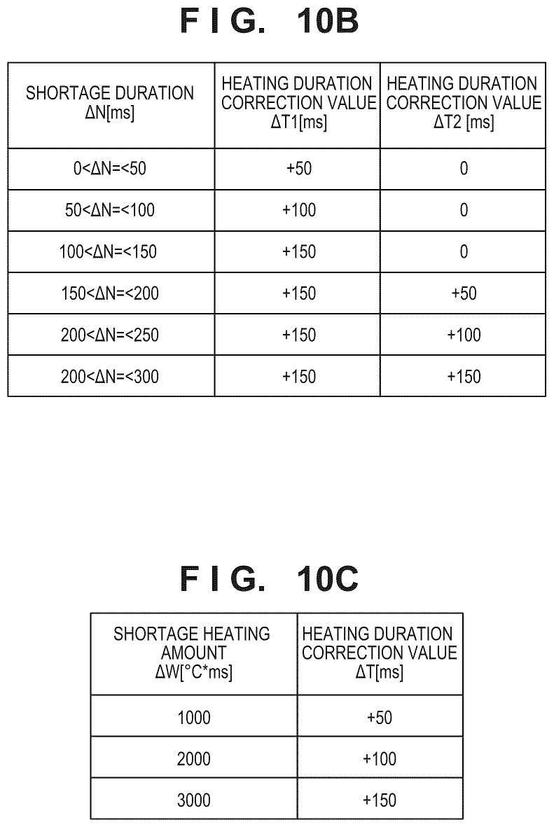

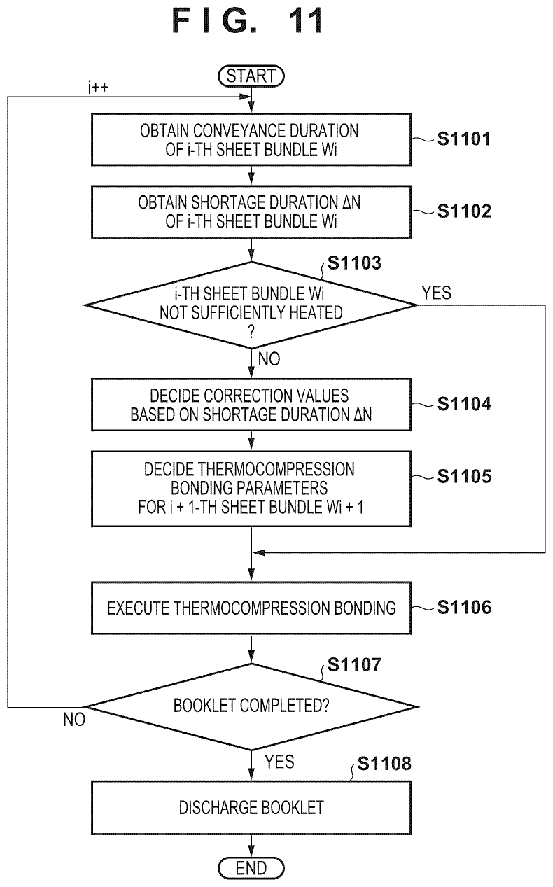

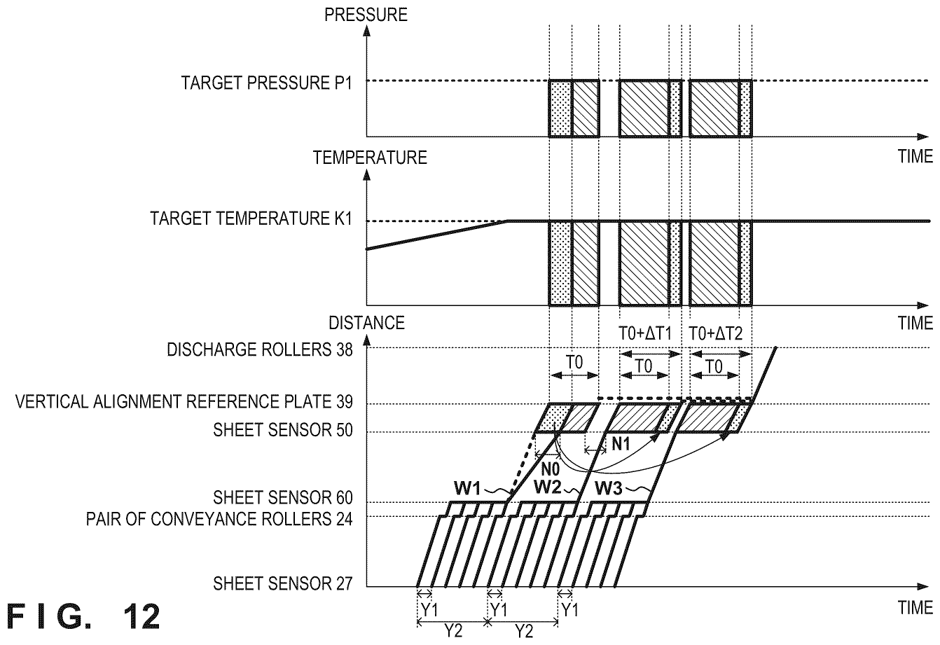

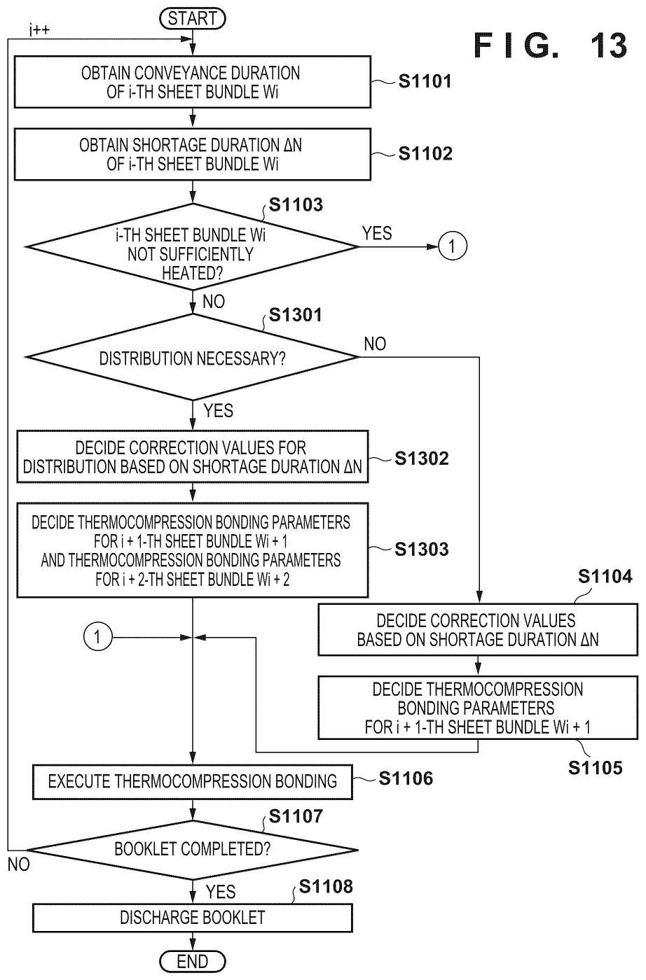

FIG. 10A illustrates an example of a table holding a relationship between the correction value ΔT for the heating duration, the correction value ΔK for the heating temperature, and the correction value ΔP for the pressing force with respect to the shortage duration ΔN. This table is stored in the memory 652. The CPU 651 refers to the table based on the shortage duration ΔN and decides the correction values ΔT, ΔK, and ΔP corresponding to the shortage duration ΔN.

The compensation for shortage in the heating amount according to the shortage duration ΔN is realized by adjusting any one of a plurality of thermocompression bonding parameters (heating duration, heating temperature, and pressing force). For example, configuration may be such that only the heating duration is adjusted, only the heating temperature is adjusted, or only the pressing force is adjusted. Alternatively, a combination of the heating duration and the heating temperature may be adjusted, or a combination of the heating duration, the heating temperature, and the pressing force may be adjusted. When there are three parameters, there are six possible combinations for the adjustment. Therefore, there is a problem as to which thermocompression bonding parameter to prioritize. For example, a configuration may be taken so as to decide that the less influence a thermocompression bonding parameter has on the life (durability), rise in temperature, and power consumption of the thermocompression bonding unit 51, the higher their degree of priority (order of priority) is. In the first embodiment, the degree of priority of the correction value ΔT for the heating duration is the highest. The degree of priority of the correction value ΔK for the heating temperature is the second highest. The degree of priority of the correction value ΔP for the pressing force is the third highest. In view of the life, rise in temperature, and power consumption of the thermocompression bonding unit 51, the heating duration, the heating temperature, and the pressing force for when there is no conveyance delay are set with a margin. That is, a design in which a maximum temperature and a maximum pressure are not used when there is no conveyance delay and the heating temperature or the pressing force can be increased when necessary is adopted.

According to FIG. 10A, when the shortage duration ΔN for the sheet bundle W1 is 0 ms<ΔN≤150 ms, the CPU 651 extends the heating duration of the sheet bundle W2 by +50 ms to +150 ms. As a result, the shortage in the heating amount is compensated for. For example, when it is important to reduce power consumption, +50 ms may be employed. Meanwhile, when reliable bonding is important, +150 ms may be employed. The correction value ΔT may be calculated so as to be proportional to ΔN and to be from +50 ms to +150 ms. As described above, ΔN and the correction values ΔT, ΔK, and ΔP may be correlated with each other.

When the shortage duration ΔN for the sheet bundle W1 is 150 ms<ΔN≤300 ms, the CPU 651 determines that the shortage in the heating amount of the sheet bundle W1 will not be sufficiently compensated for simply by correcting the heating duration of the sheet bundle W2. Therefore, the CPU 651 increases the correction value ΔK for the heating temperature while setting the correction value ΔT for the heating duration to +150 ms, which is a maximum.

When the shortage duration ΔN for the sheet bundle W1 is 300 ms<ΔN≤450 ms, the CPU 651 determines that the shortage in the heating amount of the sheet bundle W1 will not be sufficiently compensated for simply by correcting the heating duration and the heating temperature for the sheet bundle W2. Therefore, the CPU 651 sets the correction value ΔT to +150 ms, sets the correction value ΔK to +30° C., and increases the correction value ΔP for the pressing force by +1.5 kgf to +4.5 kgf.

As described above, the thermocompression bonding parameters in the thermocompression bonding for the sheet bundle W2 are adjusted based on a predecided table. As a result, the shortage in the heating amount of the sheet bundle W1 is compensated for by thermocompression bonding of the sheet bundle W2.

For example, in some cases (0 ms<ΔN≤150 ms), the shortage duration ΔN can be compensated for simply using the correction value ΔT for the heating duration. In this case, as illustrated in the timing chart of FIG. 9, the CPU 651 extends the heating duration by ΔT in the thermocompression bonding for the sheet bundle W2. As a result, the shortage in the heating amount of the sheet bundle W1 is sufficiently compensated for.

Meanwhile, in some cases (150 ms<ΔN≤300 ms), heating amount compensation according to two thermocompression bonding parameters (correction value ΔT and correction value ΔK) is necessary for the shortage duration ΔN. In this case, the CPU 651 extends the heating duration by ΔT, increases the heating temperature by ΔK, and changes the target temperature from K1 to K2 (K2>K1) in the thermocompression bonding for the sheet bundle W2. As a result, the shortage in the heating amount of the sheet bundle W1 is sufficiently compensated for.

In some cases (300 ms<ΔN≤450 ms), compensation according to three thermocompression bonding parameters (correction value ΔT, correction value ΔK, and correction value ΔP) is necessary for the shortage duration ΔN. The CPU 651 extends the heating duration by ΔT, increases the heating temperature by ΔK, and increases the pressing amount by ΔP for the sheet bundle W2. As a result, the shortage in the heating amount of the sheet bundle W1 is sufficiently compensated for.

### (10) Flowchart

FIG. 11 is a flowchart illustrating thermocompression bonding to be executed by the CPU 651 according to a control program. Here, for generalization, i is used as an index for distinguishing each sheet bundle W.

In step S1101, the CPU 651 (obtaining unit 721) obtains a conveyance duration of an i-th sheet bundle Wi. The obtaining unit 721 obtains a duration from a timing at which the leading edge of the sheet bundle Wi is detected by the sheet sensor 60 to a timing at which the leading edge of the sheet bundle Wi is detected by the sheet sensor 50 as the conveyance duration.

In step S1102, the CPU 651 (obtaining unit 721) obtains the shortage duration ΔN based on the conveyance duration of the sheet bundle Wi. The obtaining unit 721 may calculate the shortage duration ΔN using the above-described equation.

In step S1103, the CPU 651 (determination unit 722) determines whether the i-th sheet bundle Wi will not be sufficiently heated based on the shortage duration ΔN. For example, if the shortage duration ΔN exceeds 0, the determination unit 722 determines that a heating shortage will occur and proceeds from step S1103 to step S1104. If the shortage duration ΔN does not exceed 0, the determination unit 722 determines that a heating shortage will not occur and proceeds from step S1103 to step S1106.

In step S1104, the CPU 651 (decision unit 723) decides correction values for thermocompression bonding parameters to be applied to a subsequent sheet bundle i+1 based on the shortage duration ΔN. For example, the decision unit 723 may obtain a combination of types of thermocompression bonding parameters corresponding to the shortage duration ΔN and their correction values from the table illustrated in FIG. 10A.

In step S1105, the CPU 651 (decision unit 723) decides thermocompression bonding parameters to be applied to the sheet bundle i+1 based on the correction values. For example, the decision unit 723 decides a heating duration to be applied to the sheet bundle i+1 by adding the correction value ΔT to a default value of the heating duration. The decision unit 723 decides a heating temperature to be applied to the sheet bundle i+1 by adding the correction value ΔK to a default value of the heating temperature. The decision unit 723 decides pressing force to be applied to the sheet bundle i+1 by adding the correction value ΔP to a default value of the pressing force. The default values are stored in advance in the memory 652.

In step S1106, the CPU 651 (thermocompression bonding control unit 724) executes thermocompression bonding by controlling the thermocompression bonding unit 51 using the thermocompression bonding parameters decided in step S1104.

In step S1107, the CPU 651 determines whether a booklet is completed. For example, in a case of forming a booklet from the sheet bundles W1, W2, and W3, when the thermocompression bonding of the sheet bundle W3 is completed, the CPU 651 determines that the booklet is completed and proceeds from step S1107 to step S1108. If the thermocompression bonding of the sheet bundle W3 is not completed, the CPU 651 determines that the booklet is not completed, and returns from step S1107 to step S1101.

In step S1108, the CPU 651 discharges the booklet from the intermediate stack section 42 to the lower tray 37 by controlling the motors M9 and M10.

As described above, the CPU 651 corrects thermocompression bonding parameters (e.g., heating duration, heating temperature, and pressing force) in thermocompression bonding for the sheet bundle W2 based on the shortage duration ΔN of the sheet bundle W1. Accordingly, a shortage in pressure bonding of the sheet bundle W1 is less likely to occur.

(11) When Distributing Heating Amount Across Plurality of Sheet bundles

### (11-1) Basic Concept

Thus far, when a conveyance delay occurs in the sheet bundle W1, a plurality of thermocompression bonding parameters applied to thermocompression bonding of the subsequent sheet bundle W2 are corrected. However, a configuration may be taken so as to, when a conveyance delay occurs in a preceding sheet bundle Wi, adjust thermocompression bonding parameters for a plurality of subsequent sheet bundles Wi+1, Wi+2, and so on. That is, the shortage in the amount of heat corresponding to the shortage duration ΔN may be compensated for in the plurality of subsequent sheet bundles Wi+1, Wi+2, and so on.

FIG. 12 illustrates a case where a heating amount that is lacking in the sheet bundle W1 is distributed across and compensated for by thermocompression bonding for the sheet bundle W2 and thermocompression bonding for the subsequent sheet bundle W3. The CPU 651 (decision unit 723) decides a correction value ΔT1 for the heating duration to be added for the sheet bundle W2 and a correction value ΔT2 for the heating duration to be added for the sheet bundle W3 based on the shortage duration ΔN.

FIG. 10B is a table illustrating a relationship between the shortage duration ΔN and the correction value ΔT. This table is also decided at the time of designing the thermocompression bonding unit 51 and stored in a ROM area of the memory 652. The CPU 651 refers to the table based on the shortage duration ΔN and decides the correction value ΔT1 and the correction value ΔT2. The CPU 651 decides a heating temperature for the sheet bundle W2 by adding the correction value ΔT1 to a default value of a heating temperature for the sheet bundle W2. The CPU 651 decides a heating temperature for the sheet bundle W3 by adding the correction value ΔT2 to a default value of a heating temperature for the sheet bundle W3. The CPU 651 executes thermocompression bonding on each sheet bundle W using the thermocompression bonding parameters decided for each sheet bundle W.

### (11-2) Flowchart

FIG. 13 is a flowchart illustrating thermocompression bonding to be executed by the CPU 651 according to a control program. Compared to the flowchart of FIG. 11, in FIG. 13, steps S1301 to S1303 have been added between steps S1103 and S1106. Therefore, in FIG. 13, the description of FIG. 11 is incorporated into the description of matters common to FIG. 11. In step S1103, when it is determined that the i-th sheet bundle Wi is not sufficiently heated, the CPU 651 proceeds from step S1103 to step S1301.

In step S1301, the CPU 651 (determination unit 722) determines whether it is necessary to distribute a heating amount to a plurality of subsequent sheet bundles W based on the shortage duration ΔN. For example, if the shortage duration ΔN exceeds a predetermined positive threshold Nth, the determination unit 722 determines that distribution is necessary and proceeds from step S1301 to step S1302. Meanwhile, if the shortage duration ΔN does not exceed the threshold Nth, the determination unit 722 determines that distribution is unnecessary and proceeds from step S1301 to step S1104.

In step S1302, the CPU 651 (decision unit 723) decides correction values for distribution to a plurality of subsequent sheet bundles Wi+1 and Wi+2 based on the shortage duration ΔN. For example, a configuration may be taken such that the decision unit 723 references the table held in the memory 652 based on the shortage duration ΔN and obtains the correction values ΔT1 and ΔT2.

In step S1303, the CPU 651 (decision unit 723) decides the thermocompression bonding parameters for the i+1-th sheet bundle Wi+1 and the thermocompression bonding parameters for the i+2-th sheet bundle Wi+2 based on the obtained correction values for distribution. Then, the CPU 651 proceeds from step S1303 to step S1106.

As illustrated in FIG. 12, the thermocompression bonding parameters for the sheet bundles W2 and W3 are corrected based on the shortage duration ΔN of the sheet bundle W1. Accordingly, a shortage in pressure bonding of the sheet bundle W1 is less likely to occur. It is similar for second to fourth embodiments. Here, for the sake of simplicity of description, only the correction value ΔT for the heating duration is obtained. However, this is only one example. As described in connection with FIG. 10A, the correction value ΔK for the heating temperature and the correction value ΔP for the pressing force may also be distributed to a plurality of subsequent sheet bundles W.

### Second Embodiment

### (1) Basic Concept

In the first embodiment, a case in which, when a sheet bundle W is fed into the intermediate stack section 42, an lacking heating amount caused by a conveyance delay of the sheet bundle W is compensated for by thermocompression bonding of a subsequent sheet bundle W has been described. In the second embodiment, a case where one sheet S is conveyed to the intermediate stack section 42 at a time is assumed. Therefore, the thermocompression bonding unit 51 executes thermocompression bonding each time one sheet S is stacked in the intermediate stack section 42.

As one example, plain paper, thick paper i (e.g., grammage=120 g/m2), and thick paper ii (e.g., grammage=150 g/m2) are adopted as types of sheet S. For these types of sheets S, the buffer unit 80 operates as follows. In the case of plain paper, the buffer unit 80 produces a sheet bundle W by stacking a plurality of sheets S and conveys the sheet bundle W to the intermediate stack section 42. In the case of thick paper i and thick paper ii, the buffer unit 80 does not stack a plurality of sheets S. That is, the buffer unit 80 feeds one sheet S at a time to the intermediate stack section 42. This is because, when a plurality of thick sheets are stacked in the buffer unit 80, friction occurs between the plurality of sheets S, and a problem occurs in images on the sheets S.

The heating temperatures necessary for plain paper, thick paper i, and thick paper ii are each different. The target temperature of the heating temperature for plain paper is, for example, 200 degrees. The target temperature for thick paper i is 220 degrees. The target temperature for thick paper ii is 240 degrees.

Incidentally, when the user bonds a plurality of sheets S, each of a different type, by thermocompression, there is a possibility that a sheet S of a different type from a type instructed by the user will be conveyed. If the thermocompression bonding unit 51 performs thermocompression bonding at a heating temperature for the instructed type, the heating amount may be insufficient and a shortage in thermocompression bonding may occur. Therefore, in the second embodiment, when the heating amount is insufficient due to the type of a preceding sheet S being different from a type expected in advance, the CPU 651 changes thermocompression bonding parameters for a subsequent sheet S. As a result, a shortage in pressure bonding is less likely to occur. In the second embodiment, description of matters common to those of the first embodiment will be omitted.

(2) Recovery for Amount of Heat for when Type of Sheet is Different from Expected Type

Before the conveyance of a sheet S is started, the CPU 651 (obtaining unit 721) receives, from the printer control unit 600, expected type information indicating the type of the sheet S to be conveyed to the post-processing apparatus 300. The expected type information indicates, for example, a type designated by the user. After the conveyance of the sheet S is started, the CPU 651 (obtaining unit 721) receives, from the printer control unit 600, confirmed type information indicating the type of the sheet S. The confirmed type information indicates a type actually detected by the media sensor 79, which detects the type of a sheet S. The CPU 651 (determination unit 722) determines whether the expected type information matches the confirmed type information.

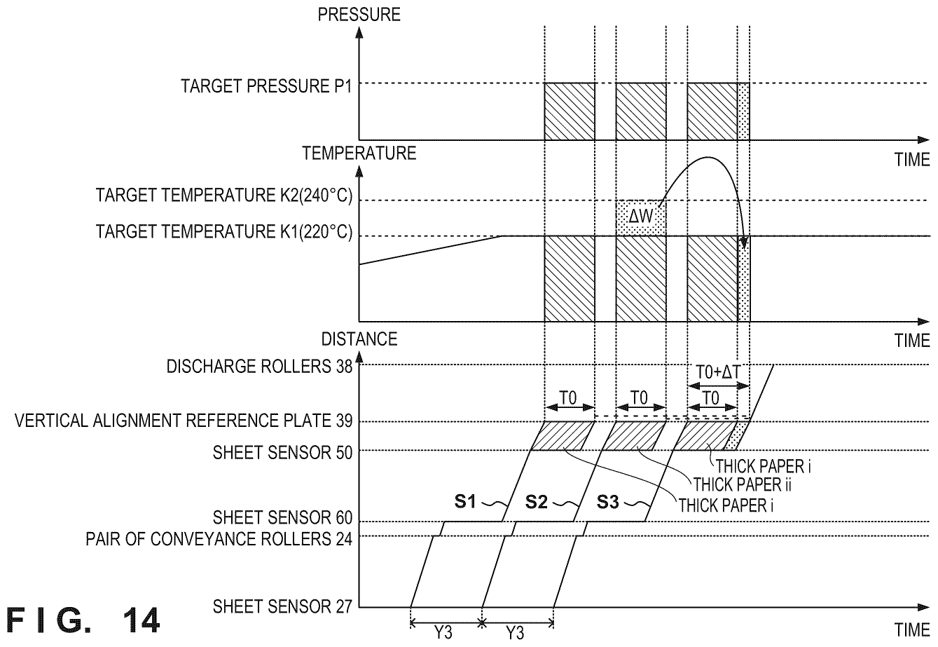

FIG. 14 is a timing chart for when the type of a sheet S is different from an expected type. The expected type information indicates that the type of sheets S1 to S3 is thick paper i. Meanwhile, the confirmed type information indicates that the type of the sheets S1 and S3 is thick paper i and the type of the sheet S2 is thick paper ii. Originally, the heating temperature of the sheet S2 must be 240 degrees. However, the conveyance of the sheet S2 and the sheet S3 has already started, and it is not possible to wait for the temperature of the thermocompression bonding unit 51 to rise. Therefore, the thermocompression bonding of the sheet S2 is executed at 220 degrees. In this case, the heating amount of the sheet S2 may be insufficient and a shortage in pressure bonding may occur. Therefore, the CPU 651 compensates for the heating amount that is lacking in the sheet S2 in the subsequent sheet S3. Here, a shortage heating amount ΔW of the sheet S2 is compensated for by the correction value ΔT for the heating duration of the subsequent sheet S3. The shortage heating amount ΔW may be calculated using an equation, Eq2.

$$Δ W = ( K 2 - K 1 ) \times T 0 \qquad Eq 2$$

Here, K2 is a target temperature necessary for an actual type of the sheet S2. K1 is a target temperature necessary for an expected type. In the case illustrated in FIG. 14, K2=240 degrees and K1=220 degrees. TO is a default thermocompression bonding duration.

FIG. 10C is a table holding a relationship between the shortage heating amount ΔW and the correction value ΔT for the heating duration. This table is also decided at the time of designing the thermocompression bonding unit 51 and stored in the memory 652. The CPU 651 refers to the table based on the shortage heating amount ΔW and decides a correction value for a thermocompression bonding parameter to be applied to a subsequent sheet S. As a result, the shortage in the heating amount of the sheet S2 is compensated for in the sheet S3.

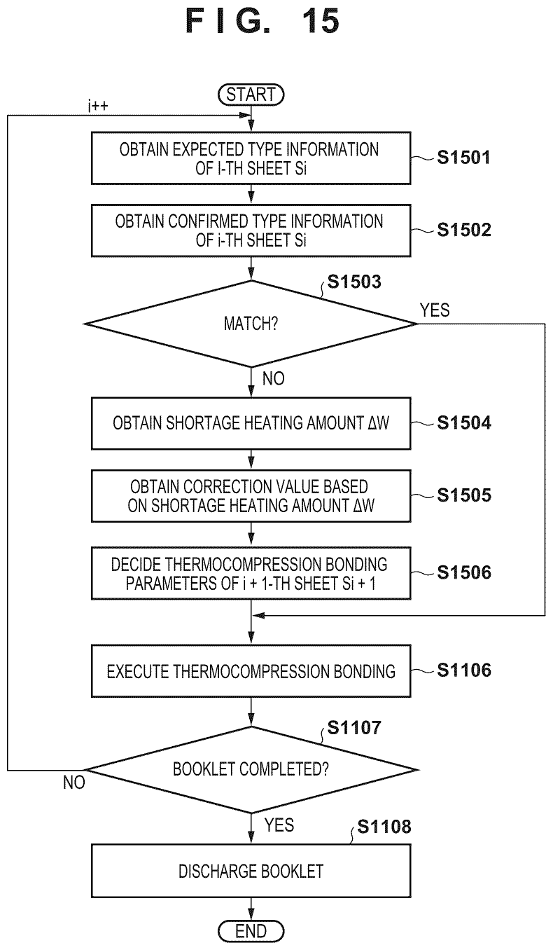

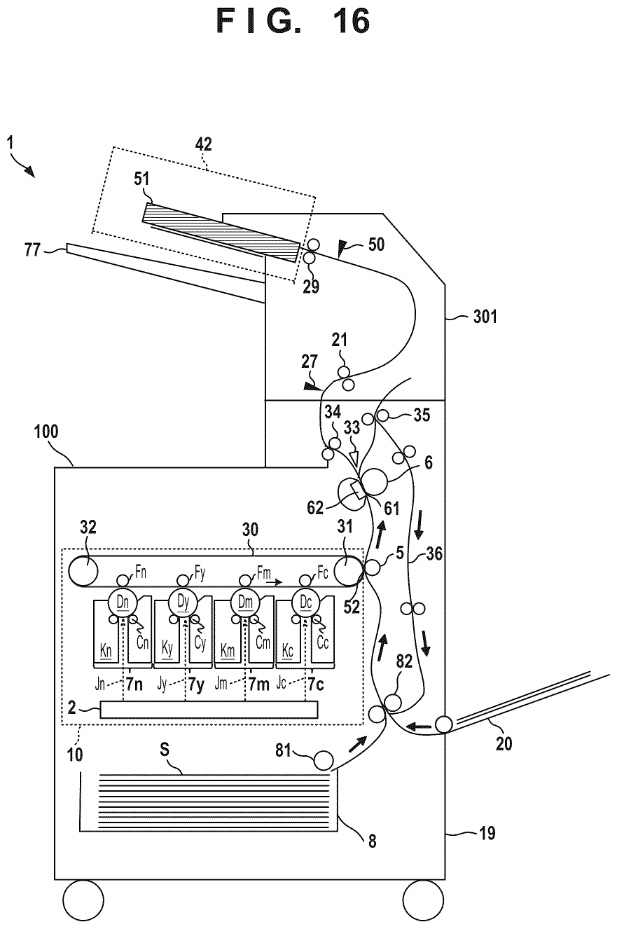

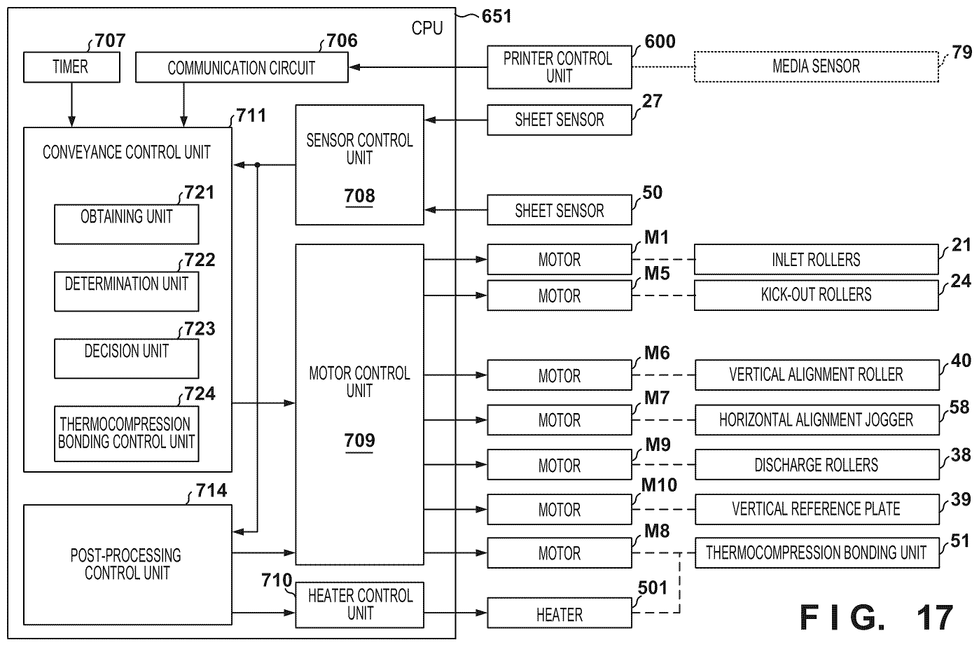

FIG. 15 is a flowchart illustrating a method of thermocompression bonding to be executed by the CPU 651 according to a control program.

In step S1501, the CPU 651 (obtaining unit 721) obtains expected type information for an i-th sheet Si from the memory 652.

In step S1502, the CPU 651 (obtaining unit 721) obtains confirmed type information for the i-th sheet Si from the image forming apparatus 100.

In step S1503, the CPU 651 (determination unit 722) determines whether the expected type information matches the confirmed type information. If the two match, the CPU 651 proceeds from step S1503 to step S1106. If the two do not match, the CPU 651 proceeds from step S1503 to step S1504.

In step S1504, the CPU 651 (obtaining unit 721) obtains the shortage heating amount ΔW. For example, the obtaining unit 721 obtains the shortage heating amount ΔW using an equation, Eq2.

In step S1505, the CPU 651 (decision unit 723) obtains a correction value based on the shortage heating amount ΔW. For example, the decision unit 723 references the table stored in the memory 652 and obtains the correction value ΔT corresponding to the shortage heating amount ΔW.

In step S1506, the CPU 651 (decision unit 723) decides thermocompression bonding parameters of the i+1-th sheet Si+1 based on the correction value. For example, the decision unit 723 decides a heating temperature T0+ΔT of the sheet Si+1 by adding the correction value ΔT to a default heating duration T0 of the sheet Si+1. Then, the CPU 651 executes the processing from step S1106 to step S1108.

As described above, according to the second embodiment, a heating amount shortage caused by the type of a preceding sheet S being different from an expected type is compensated for in a subsequent sheet S. As a result, a sufficient bonding strength is ensured while maintaining productivity.

In the above-described example, only the heating duration among a plurality of thermocompression bonding parameters is corrected, but this is only one example. As noted in the first embodiment, other thermocompression bonding parameters (e.g., heating temperature and pressing force) may be corrected in addition to or instead of the heating duration.

### Third Embodiment

### (1) Basic Concept

Although the post-processing apparatus 300 of the first embodiment includes the buffer unit 80, the buffer unit 80 is not essential. Therefore, the third embodiment relates to thermocompression bonding processing for when the post-processing apparatus 300 does not include the buffer unit 80. The description of matters described in the first embodiment or the second embodiment among matters to be described in the third embodiment will be omitted.

### (Post-Processing Apparatus)

FIG. 16 illustrates the image forming system 1 according to the third embodiment. The image forming system 1 includes the image forming apparatus 100 and a post-processing apparatus 301. The post-processing apparatus 301 is arranged in an upper portion of the image forming apparatus 100. The post-processing apparatus 301 does not include the buffer unit 80.

A sheet S discharged from the discharge rollers 34 are drawn into a conveyance path present inside the post-processing apparatus 301 by the inlet rollers 21. The sheet sensor 27 is arranged upstream of the inlet rollers 21 in the conveyance direction of the sheet S. The kick-out rollers 29 are arranged downstream of the inlet rollers 21. The kick-out rollers 29 convey the sheet S to the intermediate stack section 42. The sheet sensor 50 is arranged upstream of the kick-out rollers 29.

The intermediate stack section 42 is as already described and includes the vertical alignment plate 39 and the thermocompression bonding unit 51 and executes thermocompression bonding on a plurality of sheets S or a sheet bundle W stacked in the intermediate stack section 42. By the vertical alignment plate 39 moving from the standby position to the discharge position, a booklet held in the intermediate stack section 42 is discharged to a discharge tray 77.

### (2) Hardware

FIG. 17 illustrates electrical hardware of the post-processing apparatus 301 related to the third embodiment. Compared to the post-processing apparatus 300 of the first embodiment, regarding the post-processing apparatus 301, the motor M2 to M4 and the sheet sensor 60 related to the buffer unit 80 are merely omitted. Therefore, the description of the post-processing apparatus 300 is applied as is to the description of the post-processing apparatus 301 except for the buffer operation.

### (3) Alignment Operation

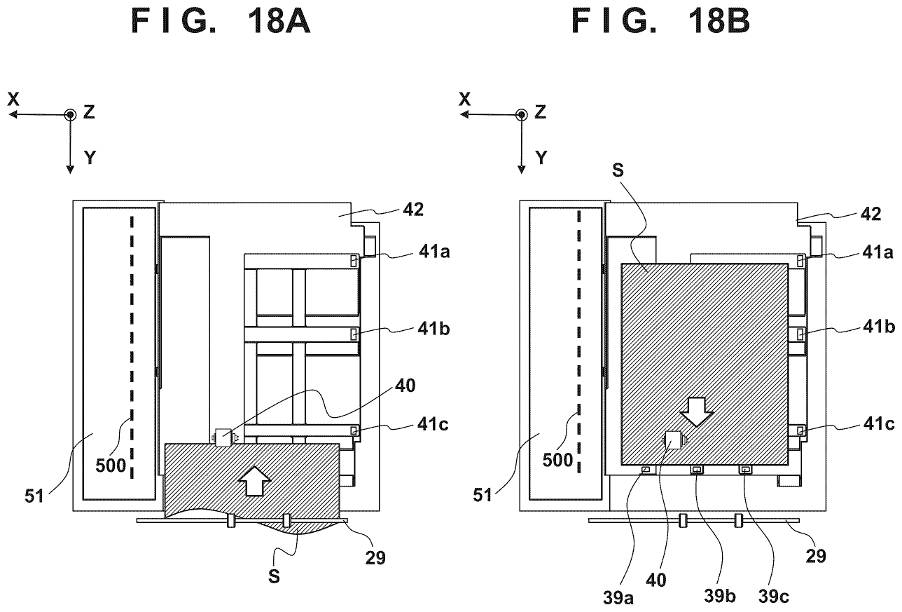

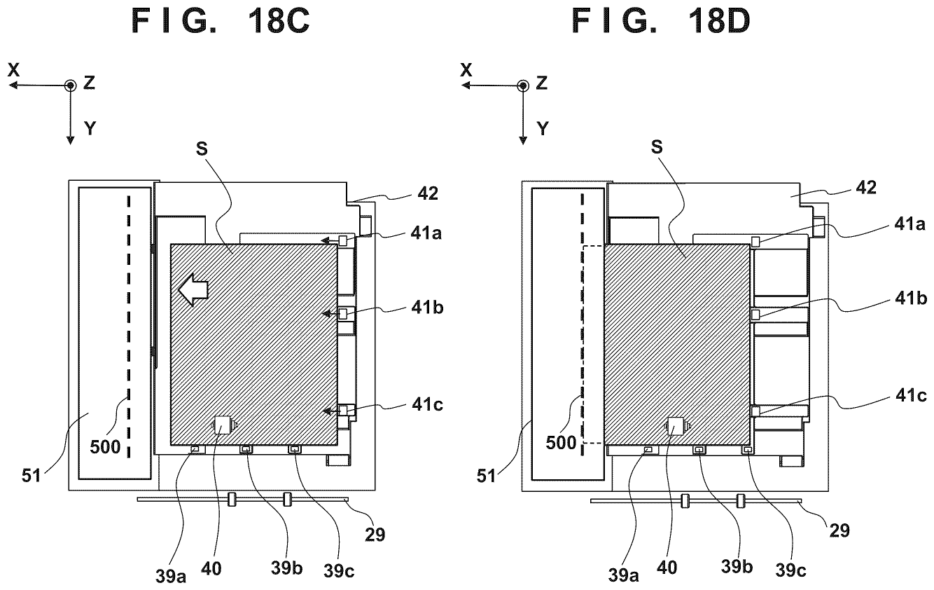

FIGS. 18A to 18D illustrate an alignment operation of a sheet S in the third embodiment. Here, a vertical direction (lengthwise direction) of a sheet S is defined as a Y direction. A horizontal direction (widthwise direction) of a sheet S is defined as an X direction. A height direction of a sheet S is defined as a Z direction.

As illustrated in FIG. 18A, a sheet S is fed to the intermediate stack section 42 by the kick-out rollers 29. As illustrated in FIG. 18B, the vertical alignment roller 40 is supported so as to be rotatable. The vertical alignment roller 40 conveys the sheet S toward the vertical alignment plate 39 at a predetermined timing. The predetermined timing is, for example, a timing at which a predetermined duration has elapsed from a timing at which the leading edge of the sheet S is detected by the sheet sensor 50. When the trailing edge of the sheet S contacts the contact members 39a to 39c of the vertical alignment plate 39, the vertical alignment roller 40 slips. As a result, the position of the sheet S in the vertical direction is organized.

As illustrated in FIG. 18C, when the sheet S reaches the contact members 39a to 39c, the horizontal alignment joggers 41a to 41c start moving in the +X direction. As illustrated in FIG. 18D, the horizontal alignment joggers 41a to 41c move in the +X direction until an edge portion of the sheet S abuts the contact surface 500. As a result, the sheet S is arranged at a predetermined position in the horizontal direction.

The alignment operation related to FIGS. 18C and 18D is linked with the thermocompression bonding processing by the thermocompression bonding unit 51. The thermocompression bonding unit 51 bonds a plurality of sheets S to each other by bonding the plurality of sheets S by thermocompression. By the thermocompression bonding unit 51 performing the thermocompression bonding processing on a sheet bundle W aligned in the vertical direction and the horizontal direction, a booklet that has been aligned in a precise manner is produced.

### (4) Recovery for Conveyance Delay

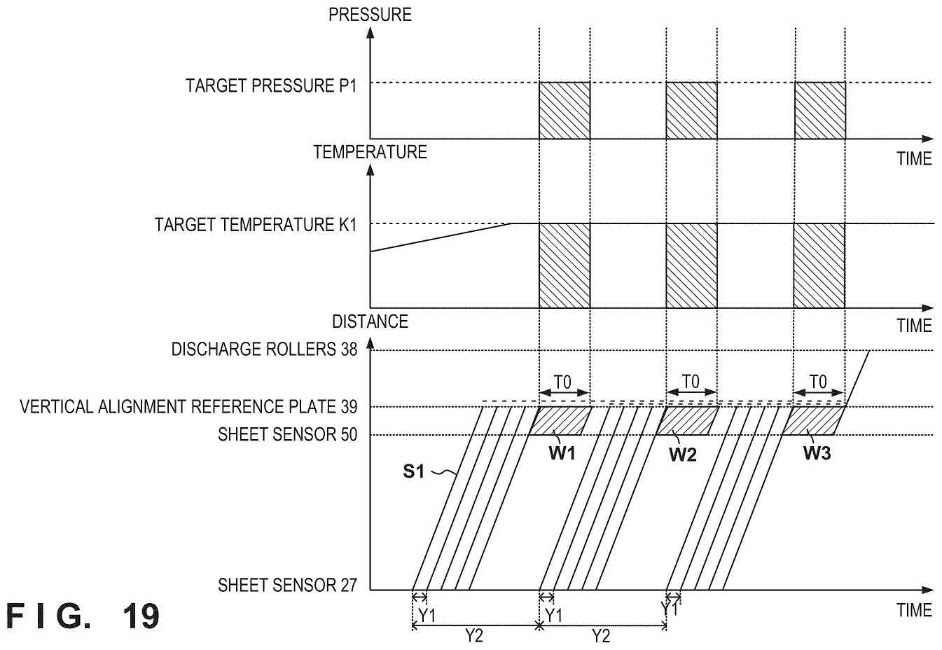

FIG. 19 is a timing chart illustrating the thermocompression bonding unit 51 executing thermocompression bonding each time five sheets S are conveyed to the intermediate stack section 42. A sheet bundle W2 and a sheet bundle W3 are also conveyed and bonded by thermocompression in the same manner as a sheet bundle W1. As illustrated in FIG. 19, the conveyance intervals between sheets S are Y1. The conveyance intervals between the sheet bundles W are Y2. A duration from conveyance to the intermediate stack section 42 until thermocompression bonding is completed is T0. Thus, T0 is a default thermocompression bonding duration (heating duration and pressing duration).

The CPU 651 controls the heater 501 until the surface temperature of the heater 501 of the thermocompression bonding unit 51 reaches the target temperature K1. The CPU 651 controls the motor M8 such that the total pressure to be applied to a sheet bundle W is the target pressure P1. During the thermocompression bonding duration T0, heating and pressing are executed.

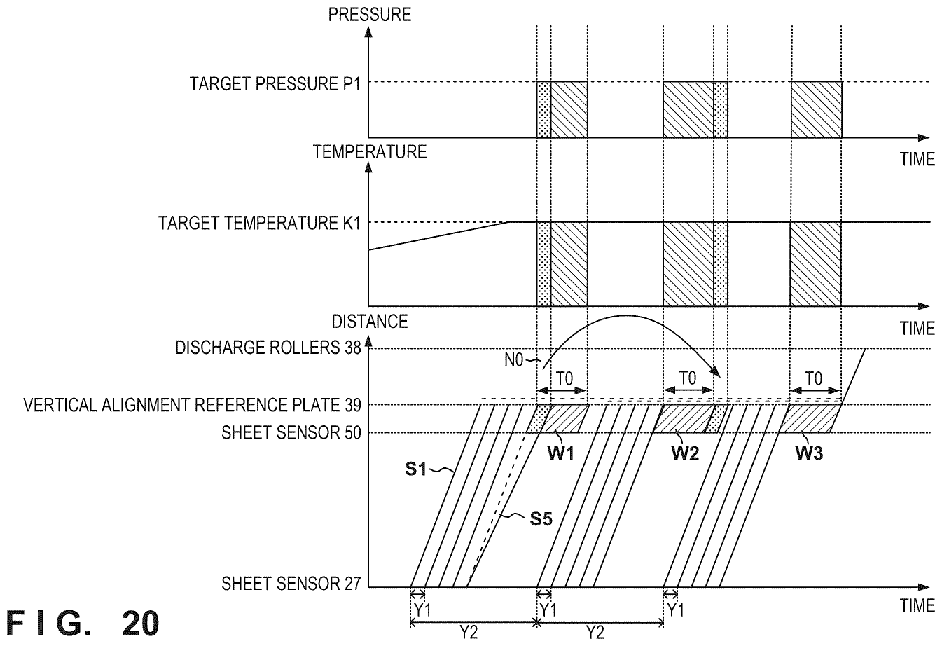

FIG. 20 illustrates an example in which a conveyance delay of a sheet S has occurred. In this example, the obtaining unit 721 measures a duration (conveyance duration) for the leading edge of a sheet S to be conveyed from the sheet sensor 27 to the sheet sensor 50, using the timer 707. A slip occurs suddenly at the inlet rollers 21, and so, the conveyance duration of a sheet S5 is longer than a specified duration. As in the first embodiment, a delay duration at this time is N0.

In the third embodiment, a method of compensating for a shortage in the heating amount when a conveyance delay occurs is similar to that of the first embodiment. That is, the CPU 651 (obtaining unit 721) obtains a conveyance duration of the last sheet S among five sheets S constituting a sheet bundle Wi as a conveyance duration of the sheet bundle Wi. The CPU 651 (obtaining unit 721) obtains the delay duration N0 based on the conveyance duration of the sheet bundle Wi. Further, the CPU 651 (obtaining unit 721) calculates the shortage duration ΔN from the delay duration N0 and the margin N1. The CPU 651 (decision unit 723) decides correction values for thermocompression bonding parameters to be applied to a subsequent sheet bundle W based on the shortage duration ΔN. The CPU 651 (decision unit 723) corrects (decides) thermocompression bonding parameters using the correction values. The correction values may be decided based on a table stored in the memory 652. As the correction values, at least one of the correction value ΔT for the heating duration, the correction value ΔK for the heating temperature, and the correction value ΔP for the pressing force is decided.

According to the third embodiment, also in the post-processing apparatus 301 configured so as to not include the buffer unit 80, the CPU 651 corrects the thermocompression bonding parameters for the subsequent sheet bundle W2 based on the shortage duration ΔN of the sheet bundle W1. As a result, a sufficient bonding strength is ensured while maintaining productivity.

### Fourth Embodiment

### (1) Basic Concept

In the second embodiment, in the post-processing apparatus 300 including the buffer unit 80, a shortage in a heating amount that occurs in conjunction with a conveyance delay of a preceding sheet S is compensated for by a thermocompression bonding parameter of a subsequent sheet S. The second embodiment is also applicable to the image forming system 1 including the post-processing apparatus 301 as in the third embodiment. That is, the shortage in a heating amount caused by an actual type and an expected type of a sheet S conveyed to the intermediate stack section 42 being different is compensated for by correcting a thermocompression bonding parameter of a subsequent sheet S. In the fourth embodiment, description of matters described in the first to third embodiments will be omitted.

(2) Recovery for when Type of Sheet is Different from Expected Type

Before the conveyance of a sheet S is started, the CPU 651 (obtaining unit 721) receives, from the printer control unit 600, expected type information indicating the type of the sheet S to be conveyed to the post-processing apparatus 301. The expected type information indicates, for example, a type designated by the user. Further, after the conveyance of the sheet S is started, the CPU 651 (obtaining unit 721) receives, from the printer control unit 600, confirmed type information indicating the type of the sheet S determined by the image forming apparatus 100. The confirmed type information indicates a type actually detected by the media sensor 79, which detects the type of a sheet S. The CPU 651 (determination unit 722) determines whether the expected type information matches the confirmed type information.

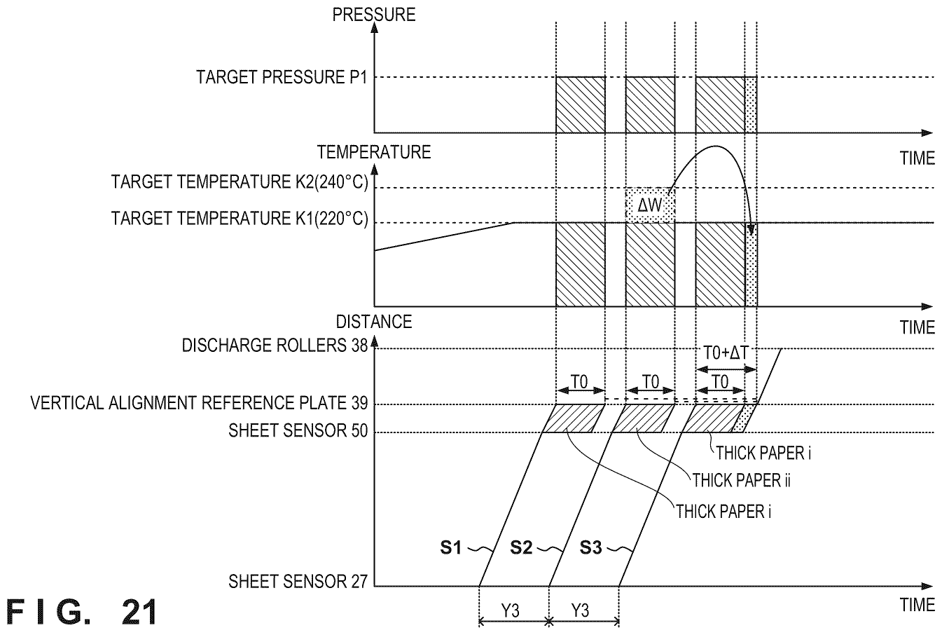

FIG. 21 is a timing chart for when the type of a sheet S is different from an expected type. The expected type information indicates that the type of sheets S1 to S3 is thick paper i. Meanwhile, the confirmed type information indicates that the type of the sheets S1 and S3 is thick paper i and the type of the sheet S2 is thick paper ii. Originally, the heating temperature of the sheet S2 must be 240 degrees. However, the conveyance of the sheet S2 and the sheet S3 has already started, and it is not possible to wait for the temperature of the thermocompression bonding unit 51 to rise. Therefore, the thermocompression bonding of the sheet S2 is executed at 220 degrees. In this case, the heating amount of the sheet S2 may be insufficient and a shortage in pressure bonding may occur. Therefore, the CPU 651 compensates for the heating amount that is lacking in the sheet S2 in the subsequent sheet S3. Here, a shortage heating amount ΔW of the sheet S2 is compensated for by the correction value ΔT for the heating duration of the subsequent sheet S3. The shortage heating amount ΔW may be calculated using an equation, Eq2.

Here, K2 is a target temperature necessary for an actual type of the sheet S2. K1 is a target temperature necessary for an expected type. In the case illustrated in FIG. 21, K2=240 degrees and K1=220 degrees. T0 is a default thermocompression bonding duration.

A method of compensating for a heating amount shortage in the fourth embodiment is the same as the compensation method of the second embodiment. That is, the CPU 651 executes the method illustrated in FIG. 15. As a result, in the fourth embodiment, the maintenance of productivity and the maintenance of a bonding strength are both achieved.

### Others

In the above-described embodiments, thermocompression bonding parameters are decided based on the shortage duration ΔN, but this is only one example. Thermocompression bonding parameters to be applied to a subsequent sheet S or sheet bundle W may be decided based on the delay duration N0 or the conveyance duration of a preceding sheet S or sheet bundle W. That is, the shortage duration ΔN may be replaced with the delay duration N0 or the conveyance duration of a preceding sheet bundle Wi.

<Technical Concept Derived from Embodiments>

### (Item 1)

The inlet rollers 21, the pair of conveyance rollers 26 and 28, and the kick-out rollers 29 are examples of a conveyance roller. The bonding toner Tn is an example of a powder bonding agent. The sheet S and the sheet bundle W are examples of a sheet group. The sheet group may be formed of one sheet S or a sheet bundle W. As illustrated in FIGS. 4B and 18D, the intermediate stack section 42 is an example of a sheet holder that holds a plurality of sheet groups by stacking a subsequent sheet group on a preceding sheet group. The CPU 651 is an example of a controller that obtains sheet information and, based on sheet information of a preceding sheet group, controls thermocompression bonding parameters to be applied to at least one subsequent sheet group of a plurality of sheet groups. The sheet information may include, for example, a conveyance duration, the delay duration N0, the shortage duration ΔN, expected type information, confirmed type information, and the like. As a result, a sufficient bonding strength is ensured while maintaining productivity of the post-processing apparatus 300.

### (Item 2)

As illustrated in FIG. 9 and the like, a thermocompression bonding parameter of an i+1-th sheet group may be corrected according to the delay duration N0 or the shortage duration ΔN. As a result, a sufficient bonding strength may be ensured while maintaining productivity.

### (Item 3)

The CPU 651 may determine whether a conveyance duration of an i-th sheet group is longer than a predetermined threshold duration. That is, the CPU 651 determines whether there is a conveyance delay. The CPU 651 may determine whether the delay duration N0 is greater than the margin N1. The CPU 651 reduces a thermocompression bonding duration to be applied to the i-th sheet group and increases at least one of a thermocompression bonding duration, a heating temperature, and a pressing force to be applied to the i+1-th sheet group. As a result, a sufficient bonding strength may be ensured while maintaining productivity.

### (Item 4)

As described with reference to FIG. 10B, thermocompression bonding parameters for a plurality of subsequent sheet groups may be corrected such that a heating amount to be supplied to a preceding sheet group is a sufficient amount. As a result, a sufficient bonding strength may be ensured while maintaining productivity.

### (Item 5)

As described in connection with FIG. 10A, there may be an order of priority (degree of priority) for the thermocompression bonding duration, the heating temperature, and the pressing force. The CPU 651 may select a set of a plurality of thermocompression bonding parameters according to the order of priority. For example, the order of priority may be decided so as to emphasize the durability of the thermocompression bonding unit 51.

### (Item 6)

The shortage duration ΔN is an example of the conveyance duration of the i-th sheet group. The memory 652, the table illustrated in FIG. 10A, and the like are examples of a storage unit. The correction values ΔT, ΔK, and ΔP are examples of an amount of increase. A table may be realized by a mathematical function or a program module.

### (Item 7)

When the i-th sheet group is delayed, an amount of heat to be applied to the i+1-th sheet group may be increased from a specified amount. The heat applied to the i+1-th sheet group also propagates to the i-th sheet group. As a result, a heating amount of the i-th sheet group increases.

### (Item 8)

When the i-th sheet group is delayed, an amount of heat to be applied to the i+1-th sheet group and an i+2-th sheet group may be increased from a specified amount. The heat applied to the i+1-th sheet group also propagates to the i-th sheet group. The heat applied to the i+2-th sheet group also propagates to the i-th sheet group through the i+1-th sheet group. As a result, the heating amount of the i-th sheet group increases.

### (Item 9)

Due to a delay of the i-th sheet group, the heating amount of the i-th sheet group is insufficient. Therefore, in order to compensate for this shortage, an amount of heat to be supplied to a plurality of subsequent sheet groups may be increased. In FIG. 10B, a heating amount is distributed between two sheet groups, but the heating amount may be distributed among three or more sheet groups.

### (Item 10)

In FIG. 1, a section from the sheet sensor 60 to the sheet sensor 50 is an example of a predetermined conveyance section. In FIG. 16, a section from the sheet sensor 27 to the sheet sensor 50 is an example of a predetermined conveyance section. The CPU 651 may adjust a thermocompression bonding parameter to be applied to the i-th sheet group according to the conveyance duration of the i-th sheet group. As illustrated in FIG. 9, a default thermocompression bonding duration is T0. Regarding the sheet bundle W1, a conveyance delay of a conveyance duration N0 may occur. In this case, a difference between the default thermocompression bonding duration T0 and the conveyance duration N0 may be assumed as an actual thermocompression bonding duration. This may mean that an end time of thermocompression bonding of the sheet bundle W1 is not changed from a specified time. Alternatively, in view of the margin N1, the end time of thermocompression bonding of the sheet bundle W1 may be shifted. If N0=<N1, a thermocompression bonding duration of the sheet bundle W1 is maintained at T0. If N0>N1, the thermocompression bonding duration of the sheet bundle W1 is T0-ΔN. ΔN is a difference between N0 and N1. In particular, if N0>N1, compensation through a subsequent sheet group is necessary.

### (Item 11)

As described in the first and third embodiments, the sheet group may be a sheet bundle W constituted by a plurality of sheets S. As described in the second and fourth embodiments, the sheet group may be constituted by one sheet S.

### (Item 12)

The buffer unit 80 is an example of the production unit. The intermediate stack section 42 of the post-processing apparatus 301 is an example of a production unit.

### (Item 13)

As illustrated in FIG. 1, the pair of conveyance rollers 26 and 28, and the kick-out rollers 29 are examples of a conveyance unit.

### (Item 14)

As illustrated in FIGS. 18A to 18D, the intermediate stack section 42 may function as a unit for producing a sheet bundle.

### (Item 15)

As described in the second and fourth embodiments, expected type information and confirmed type information are examples of the sheet information. If an expected type is different from an actual type, a heating amount may be insufficient. In this case, the heating amount may be increased in a subsequent sheet S. As a result, a sufficient bonding strength is ensured while maintaining productivity.

### (Item 16)

If a shortage in a heating amount occurs for the i-th sheet Si, the CPU 651 may distribute the heating amount among a plurality of subsequent sheets Si+1, Si+2, and so on.

### (Item 17)

The second and fourth embodiments mainly illustrate a grammage of a sheet S. However, a type of sheet may be a material related to an amount of heat, presence or absence of coating, or the like.

### (Item 18)

The image forming unit 10 is an example of an image forming unit. The process cartridge 7n, the transfer belt 30, and the like are examples of an application unit.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-123759, filed Jul. 28, 2023 which is hereby incorporated by reference herein in its entirety.

What is claimed is:

1. A post-processing apparatus comprising:
a conveyance roller configured to convey a plurality of sheet groups, each to which a bonding agent has been applied;
a sheet holder configured to hold the plurality of sheet groups by stacking a subsequent sheet group on a preceding sheet group;
a thermocompression bonding unit configured to produce a booklet by applying heat and pressure to the plurality of sheet groups held in the sheet holder; and
a controller configured to:
obtain sheet information indicating a type of sheet or a conveyance duration of a preceding sheet group among a plurality of sheet groups; and
control a thermocompression bonding parameter to be applied to at least one subsequent sheet group of the preceding sheet group among the plurality of sheet groups in the thermocompression bonding unit based on the sheet information.

2. The post-processing apparatus according to claim 1, wherein
the controller is further configured to adjust a thermocompression bonding parameter of an i+1-th sheet group stacked on an i-th sheet group, in addition to a thermocompression bonding parameter to be applied to the i-th sheet group, according to a conveyance duration of the i-th sheet group among the plurality of sheet groups.

3. The post-processing apparatus according to claim 2, wherein
in a case where the conveyance duration of the i-th sheet group is longer than a predetermined threshold duration,
the controller reduces a thermocompression bonding duration as the thermocompression bonding parameter to be applied to the i-th sheet group by the thermocompression bonding unit, and
the controller increases at least one of a thermocompression bonding duration, a heating temperature, and a pressing force as the thermocompression bonding parameter to be applied to the i+1-th sheet group by the thermocompression bonding unit.

4. The post-processing apparatus according to claim 3, wherein
the controller further increases at least one of a thermocompression bonding duration, a heating temperature, and a pressing force as a thermocompression bonding parameter to be applied to an i+2-th sheet group stacked on the i+1-th sheet group.

5. The post-processing apparatus according to claim 3, wherein
an order of priority is set in advance for the thermocompression bonding duration, the heating temperature, and the pressing force, which are the thermocompression bonding parameter, and which of the thermocompression bonding duration, the heating temperature, and the pressing force is to be increased is decided according to the order of priority.

6. The post-processing apparatus according to claim 4, further comprising:
a storage unit configured to store a combination of the conveyance duration of the i-th sheet group, a type of the thermocompression bonding parameter to be applied to the i+1-th sheet group and an increase amount thereof, a type of the thermocompression bonding parameter to be applied to the i+2-th sheet group and an increase amount thereof,
wherein the controller obtains a combination of the type of the thermocompression bonding parameter to be applied to the i+1-th sheet group and the increase amount thereof and the type of the thermocompression bonding parameter to be applied to the i+2-th sheet group and the increase amount thereof, which correspond to the conveyance duration of the i-th sheet group, from the storage unit.

7. The post-processing apparatus according to claim 1, wherein
when an amount of heat to be supplied from the thermocompression bonding unit to an i-th sheet group is insufficient due to the i-th sheet group among the plurality of sheet groups arriving late in the sheet holder, the controller increases an amount of heat to be supplied from the thermocompression bonding unit to an i+1-th sheet group stacked on the i-th sheet group.

8. The post-processing apparatus according to claim 1, wherein
when an amount of heat to be supplied from the thermocompression bonding unit to an i-th sheet group is insufficient due to the i-th sheet group among the plurality of sheet groups arriving late in the sheet holder, the controller increases an amount of heat to be supplied from the thermocompression bonding unit to an i+1-th sheet group stacked on the i-th sheet group and an amount of heat to be supplied from the thermocompression bonding unit to an i+2-th sheet group stacked on the i+1-th sheet group.

9. The post-processing apparatus according to claim 6, wherein
the controller distributes, between an amount of heat for the i+1-th sheet group and an amount of heat for the i+2-th sheet group, an amount of heat that is lacking for an amount of heat that is necessary for achieving a target bonding strength for the i-th sheet group due to a delay of the i-th sheet group.

10. The post-processing apparatus according to claim 1, wherein
the controller obtains a conveyance duration of each sheet group conveyed through a predetermined conveyance section by the conveyance roller as the sheet information, and
the controller adjusts a thermocompression bonding parameter to be applied to an i-th sheet group according to a conveyance duration of the i-th sheet group among the plurality of sheet groups.

11. The post-processing apparatus according to claim 1, wherein
each of the plurality of sheet groups is one sheet or a sheet bundle constituted by a plurality of sheets.

12. The post-processing apparatus according to claim 1, further comprising:
a production unit configured to produce a sheet bundle constituted by a plurality of sheets as the sheet group.

13. The post-processing apparatus according to claim 12, wherein
the conveyance roller is configured to convey the sheet bundle produced by the production unit to the sheet holder.

14. The post-processing apparatus according to claim 12, wherein
the sheet holder includes the production unit.

15. The post-processing apparatus according to claim 1, wherein
each of the plurality of sheet groups is constituted by one sheet, and
the controller obtains the sheet information indicating a type of each sheet and, in a case where a type of an i-th sheet conveyed to the sheet holder is different from a type expected in advance, adjusts a thermocompression bonding parameter to be applied to an i+1-th sheet stacked on the i-th sheet in the sheet holder.

16. The post-processing apparatus according to claim 15, wherein
in a case where the type of the i-th sheet conveyed to the sheet holder is different from the type expected in advance, the controller adjusts a thermocompression bonding parameter to be applied to an i+2-th sheet stacked on the i+1-th sheet in the sheet holder.

17. The post-processing apparatus according to claim 15, wherein
the type of sheet is at least one of a material, a grammage, and presence or absence of coating of a sheet related to an amount of heat necessary for thermocompression bonding of that sheet.

18. An image forming system comprising an image forming apparatus and a post-processing apparatus,
the image forming apparatus comprising:
an image forming unit configured to form an image on a plurality of sheets;
an application unit configured to apply a bonding agent on the plurality of sheets; and
a discharge roller configured to discharge the plurality of sheets to the post-processing apparatus in order, and
the post-processing apparatus comprising:
a conveyance roller configured to convey a plurality of sheet groups, each to which a bonding agent has been applied and constituted by a sheet discharged from the image forming apparatus;
a sheet holder configured to hold the plurality of sheet groups by stacking a subsequent sheet group on a preceding sheet group;
a thermocompression bonding unit configured to produce a booklet by applying heat and pressure to the plurality of sheet groups held in the sheet holder; and
a controller configured to:
obtain sheet information indicating a type of sheet or a conveyance duration of a preceding sheet group among a plurality of sheet groups; and
control a thermocompression bonding parameter to be applied to at least one subsequent sheet group of the preceding sheet group among the plurality of sheet groups in the thermocompression bonding unit based on the sheet information.
